(19) United States
(12) Patent Application Publication
(10) Pub. No.: US 2015/0296867 A1
(43) Pub. Date: Oct. 22, 2015

(54) METHODS FOR EXTRUDING POWERED NUTRITIONAL PRODUCTS USING A HIGH SHEAR ELEMENT

(71) Applicants: ABBOTT LABORATORIES, Abbott Park, IL (US); ABBOTT GMBH & CO. KG, Ludwigshafen (DE)

(72) Inventors: TERRENCE MAZER, New Albany, OH (US); THOMAS KESSLER, Schifferstadt (DE)

(73) Assignee: ABBOTT LABORATORIES, Abbott Park, IL (US)

(21) Appl. No.: 14/651,875

(22) PCT Filed: Dec. 12, 2013
(86) PCT No.: PCT/US2013/075029

§ 371 Date: Jun. 12, 2015

Related U.S. Application Data
(60) Provisional application No. 61/737,470, filed on Dec. 14, 2012.

(51) Int. Cl. A23P 1/12; A23L 1/00

(52) U.S. Cl. CPC A23P 1/12; A23L 1/0076; A23L 1/0035; A23V 2002/00

(57) ABSTRACT

A method of producing an emulsion and an extrudate for a powdered nutritional product is provided. The method includes utilizing an extruder (10) that contains a high shear element (32) positioned within the barrel of the extruder (20). The use of a high shear element (32) positioned within the barrel of the extruder (20) allows both emulsification and extrusion of the ingredients to occur within the barrel of the extruder (20). A first portion of ingredients comprising a slurry is processed by the high shear element (32) to form an emulsion. The emulsion is then combined with a second portion of ingredients and extruded to form an extrudate for the desired powdered nutritional product. In some embodiments, the high shear element (32) may comprise a shearing disc or a pair of shearing discs. The extruder (10) may comprise a single screw extruder, a twin screw extruder, or any other suitable type of extruder.

### CROSS-REFERENCE TO RELATED APPLICATIONS

This application claims priority to and any benefit of U.S. Provisional Application No. 61/737,470, filed Dec. 14, 2012, the entire contents of which are incorporated by reference in its entirety.

### TECHNICAL FIELD

The present disclosure relates to extruders and related extrusion methods for manufacturing powdered nutritional products using an internal high shear element, and, more specifically, to extruders and related extrusion methods designed to provide a stable emulsion to be used to produce powdered nutritional products.

### BACKGROUND

Nutritional formulas today are well known for a variety of nutritional or disease specific applications in infants, children, and adults. These formulas most typically contain a balance of proteins, carbohydrates, lipids, vitamins, minerals, and other nutrients tailored to the nutritional needs of the intended user, and include product forms such as reconstitutable powders, ready-to-feed liquids, dilutable liquid concentrates, nutritional bars, and others.

Powdered nutritional products, including both powdered infant formulas and powdered adult nutritional products generally contain from about 0.5% to about 35% (by weight) fat. In order for the finished product to be package stable (i.e., not subject to significant oxidation and rancidity) and not have significant fat separation when reconstituted, during manufacturing the fat component is generally sheared to globules having a size of between about 0.1-100 microns while simultaneously emulsifying the sheared fat globules with hydrated protein with or without other additional emulsifiers.

This shearing and emulsifying has traditionally been accomplished by preparing a high solids water slurry (i.e. 30% to 60% total solids) and pumping the slurry through a high pressure homogenizer located external to the extruder with a homogenization pressure between 1500 and 4500 psig. The slurry is then typically evaporated to about 45% to 60% total solids and spray dried. This generally produces stable fat that is not subject to substantial oxidation during storage and is easily reconstituted.

Although extruders and related methods are known as highly efficient methods that significantly minimize the amount of water and energy needed and that are capable of producing pellets or cake that can be dried and ground into powdered material, extruders using conventional processing elements and related methods have generally not been used to date to prepare the emulsion required to produce powdered nutritional products because existing extruders and related methods are not generally known to consistently produce a finished powdered nutritional product with a fat emulsion that is sufficiently stable for commercial purposes without utilizing additional equipment to prepare the emulsion external to the extruder. Extruders using conventional processing elements and related methods are not generally known to be able to adequately emulsify the fat required by powdered nutritional products within the extruder itself.

Without proper emulsification of the fat globules prior to extrusion, the fat is subject to oxidation and rancidity during storage and fat separation during reconstitution.

While a variety of extruders and related methods have been made and used, it is believed that no one prior to the inventors has made or used an invention as described herein.

### SUMMARY

A method of producing an emulsion and an extrudate for a powdered nutritional product within an extruder is disclosed. The method for producing an emulsion includes the steps of: a) providing an extruder, wherein the extruder includes i) a barrel, and ii) a high shear element positioned within the barrel; b) delivering a first portion of ingredients to the high shear element; and c) emulsifying the first portion of ingredients by processing the first portion ingredients through the high shear element to produce an emulsion, wherein, prior to emulsification, the first portion of ingredients comprises a slurry. The method for producing an extrudate further includes the steps of: d) delivering a second portion of ingredients into the barrel via a feeder for the second portion of ingredients; e) combining the emulsion and the second portion of ingredients to form an extrudate; and f) processing the extrudate through the extruding section.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a block diagram of an exemplary extruder wherein the mixing element is positioned inside of the extruder barrel;

FIG. 2 depicts a side, cross-sectional view of the extruder of FIG. 1, wherein the extruder comprises a single screw extruder;

FIG. 3 depicts a side, cross-sectional view of the extruder of FIG. 1, wherein the extruder comprises a twin screw extruder;

FIG. 4 depicts a block diagram of an alternate exemplary extruder wherein the mixing element is positioned outside of the extruder barrel;

FIG. 5 depicts a side, cross-sectional view of the extruder of FIG. 4, wherein the extruder comprises a single screw extruder;

FIG. 6 depicts a side, cross-sectional view of the extruder of FIG. 4, wherein the extruder comprises a twin screw extruder;

FIG. 7 depicts a front, perspective view of a pair of exemplary shearing discs;

FIG. 8 depicts a front view of one of the pair of shearing discs of FIG. 7;

FIG. 9 depicts a front, perspective view of the pair of shearing discs of FIG. 7 respectively mounted on a pair of central shafts;

FIG. 10 is a photograph of sample 403A taken under ambient lighting at the 25 hour stage during the first set of analysis;

FIG. 11 is a photograph of sample 403A taken under oblique lighting at the 25 hour stage during the first set of analysis;

FIG. 12 is a photograph of sample 403B taken under ambient lighting at the 25 hour stage during the first set of analysis;

FIG. 13 is a photograph of sample 403B taken under oblique lighting at the 25 hour stage during the first set of analysis;

FIG. 14 is a photograph of sample 408A taken under ambient lighting at the 25 hour stage during the first set of analysis;

FIG. 15 is a photograph of sample 408A taken under oblique lighting at the 25 hour stage during the first set of analysis;

FIG. 16 is a photograph of sample 408B taken under ambient lighting at the 25 hour stage during the first set of analysis;

FIG. 17 is a photograph of sample 408B taken under oblique lighting at the 25 hour stage during the first set of analysis;

FIG. 18 is a photograph of dyed sample 403A taken under ambient lighting at the 25 hour stage during the second set of analysis;

FIG. 19 is a photograph of dyed sample 403A taken under oblique lighting at the 25 hour stage during the second set of analysis;

FIG. 20 is a photograph of dyed sample 403B taken under ambient lighting at the 25 hour stage during the second set of analysis;

FIG. 21 is a photograph of dyed sample 403B taken under oblique lighting at the 25 hour stage during the second set of analysis;

FIG. 22 is a photograph of dyed sample 408A taken under ambient lighting at the 25 hour stage during the second set of analysis;

FIG. 23 is a photograph of dyed sample 408A taken under oblique lighting at the 25 hour stage during the second set of analysis;

FIG. 24 is a photograph of dyed sample 408B taken underambient lighting at the 25 hour stage during the second set of analysis; and

FIG. 25 is a photograph of dyed sample 408B taken under oblique lighting at the 25 hour stage during the second set of analysis.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The extruders and related methods of the present disclosure are directed to preparing nutritional powdered products by processing at least a portion of the ingredients through a high shear element located within the extruder. The elements or features of the various embodiments are described in detail hereinafter.

The term “powdered nutritional product” as used herein generally refers to a nutritional formulation, which is designed for infants, children, or adults to contain sufficient protein (which can be intact protein, protein hydrolysate, or a combination or both intact protein and protein hydrolysate), carbohydrate, fat, vitamins, minerals, and other nutrients to potentially serve as the sole source of nutrition when provided in sufficient quantity. The term “powdered nutritional product” includes powdered infant formulas, powdered pediatric formulas, powdered adult nutritional products, and powdered nutritional products generally.

The term “powdered infant formula” as used herein includes both powdered infant formulas and powdered toddler formulas, wherein infant formulas are intended for infants up to about 1 year of age and toddler formulas are intended for children from about 1 year of age to about 10 years of age.

The term “powdered adult nutritional product” as used herein includes formulas for generally maintaining or improving the health of an adult, and includes those formulas designed for adults who need to control their blood glucose.

The term “nutritional powder,” as used herein, unless otherwise specified, refers to nutritional products in flowable or scoopable form that can be reconstituted with water or another aqueous liquid prior to consumption and includes both spray dried and drymixed/dryblended powders or a combination of spray dried and drymixed/dryblended powders.

As used herein, “melting” means transition into a liquid state in which it is possible for one component to be homogeneously embedded in the other. Melting usually involves heating above the softening point of the material.

The term “ready-to-feed,” as used herein, unless otherwise specified, refers to formulas in liquid form suitable for administration to an infant, child or adult, including reconstituted powders, diluted concentrates, and manufactured liquids.

The term “shelf life” as used herein refers to a product's commercially viable life-span, after which the product is unfit or undesirable for sale, consumption, or both.

As used herein, the term “stable” refers to a powdered nutritional product that does not exhibit significant creaming or free oil after being reconstituted to the specified concentration and held under refrigerated conditions for 24 hours and then allowed to warm to room temperature for 1 hour.

As used herein, the term “creaming” refers to a layer higher in oil than the rest of the liquid that has a density lower than the remaining liquid, thereby causing it to rise to the top of the liquid.

As used herein, the term “free oil” refers to a layer of principally oil with a density that is lower than cream or the remaining liquid, thereby causing it to rise to the top of the liquid, or to the top of the cream layer if one exists.

The term “processing elements” as used herein refers to kneading elements, mixing elements, Z elements, T elements, and/or conveying elements that may be mounted on the central shaft(s) of an extruder.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified. All numerical ranges as used herein, whether or not expressly preceded by the term “about,” are intended and understood to be preceded by that term, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

All documents (patents, patent applications and other publications) cited in this application are incorporated herein by reference in their entirety.

Powdered nutritional products disclosed herein may also be substantially free of certain ingredients or features described herein, provided that the remaining formula still contains all of the required ingredients or features as described herein. In this context, the term “substantially free” means that the selected composition contains less than a functional amount of the optional ingredient, typically less than about 0.1% by weight, and also including zero percent by weight, of such optional or selected essential ingredient.

The powdered nutritional products and corresponding methods of manufacture of the present disclosure may comprise, consist of, or consist essentially of the essential elements, steps, and limitations of the disclosure as described herein, as well as any additional or optional ingredients, components, steps, or limitations described herein or otherwise useful in powdered nutritional product applications.

Product Form

The products produced utilizing the high shear element extruder and related processes of the present disclosure are powdered nutritional products. These products are generally mixed with water or another liquid and reconstituted prior to use.

The products of the present disclosure generally have a moisture content of from about 2% to about 5% (by weight), or even from about 2% to about 4% (by weight), or even from about 2% to about 3% (by weight), or even from about 2.5% to about 3% (by weight). The final moisture required may be determined by the specific formulation in order to have water activity of about 0.86 or less in order to be microbiologically stable.

The powdered products of the present disclosure preferably have a free fat level of less than about 5%, preferably of less than about 3%, or more preferably less than about 2%, or even more preferably of less than about 1% by weight of the powdered nutritional product. By limiting the free fat level of the powdered product, the shelf life is extended as the product is less susceptible to rancidity. Additionally, by limiting the free fat level of the powdered product, the product can be easily reconstituted without significant fat separation.

The products of the present disclosure may generally have a shelf life of at least about 3 months, or at least about 4 months, or at least about 5 months or at least about 12 months, or at least about 18 months, or at least about 36 months, including from about 6 to about 36 months.

The products of the present disclosure may be formulated with sufficient kinds and amounts of nutrients so as to provide a sole, primary, or supplemental source of nutrition, or to provide a specialized nutritional formulation for use in individuals afflicted with specific diseases or conditions.

Macronutrients

The powdered products of the present disclosure comprise at least fat, protein, and carbohydrate. Generally, any source of fat, protein, and carbohydrate that is known or otherwise suitable for use in powdered nutritional products may also be suitable for use herein, provided that such macronutrients are also compatible with the essential elements of the nutritional formulations as defined herein.

Although total concentrations or amounts of the fat, protein, and carbohydrates may vary depending upon the nutritional needs of the intended user, such concentrations or amounts most typically fall within one of the following embodied ranges, inclusive of any other essential fat, protein, and or carbohydrate ingredients as described herein.

Carbohydrate

The powdered nutritional products of the present disclosure may comprise a carbohydrate source.

When the powdered nutritional product is a powdered infant formula, the carbohydrate component is present in an amount of from about 30% to about 85%, including from about 45% to about 60%, including from about 50% to about 55% by weight of the powdered infant formula. The carbohydrate source may be any known or otherwise suitable source that is safe and effective for oral administration and is compatible with the essential and other ingredients in the selected product form.

When the powdered nutritional product is a powdered adult nutritional product, the carbohydrate component is present in an amount of from about 5% to about 60%, including from about 7% to about 40%, including from about 10% to about 25%, by weight of the powdered adult nutritional product. The carbohydrate source may be any known or otherwise suitable source that is safe and effective for oral administration and is compatible with the essential and other ingredients in the selected product form.

Suitable carbohydrates or carbohydrate sources for use in the powdered nutritional products include octenyl succinic anhydride (OSA) starch, glycerin, sucrose, dextrins, maltodextrin. tapioca maltodexrin, corn syrup, tapioca syrup, isomaltulose, sucromalt, lactose, fructose, galactose, both unhydrolyzed and partially hydrolyzed gums including gum Arabic, also known as gum acacia, xanthan gum, gum tragacanth, and guar gum, vegetable fibers, glucose, maltose, cooked and uncooked waxy and non-waxy corn starch, cooked and uncooked waxy and non-waxy tapioca starch, cooked and uncooked waxy and non-waxy rice starch, cooked and uncooked waxy or non-waxy potato starch, galacto-oligosaccharides (GOS), fructo-oligosaccharides (FOS) including short chain, moderate length chain, and long chain fructo-oligosaccharides, alpha-lactose, beta-lactose, polydextrose, tagatose, and combinations thereof. The starches listed above include both native, chemically modified, or both versions.

Other suitable carbohydrates include any dietary fiber or fiber source, non-limiting examples of which include insoluble dietary fiber sources such as oat hull fiber, pea hull fiber, soy hull fiber, soy cotyledon fiber, sugar beet fiber, cellulose, microcrystalline cellulose, corn bran, rice bran, wheat bran, oat bran, barley bran, and combinations thereof

The carbohydrate for use in the nutritional formulation may therefore include soluble fiber, insoluble fiber, or both, or other complex carbohydrate, preferably having a DE (dextrose equivalent) value of less than about 40, including less than 20, and also including from 1 to 10.

Fat

The powdered nutritional products of the present disclosure may comprise a fat or fat source.

When the powdered nutritional product is a powdered infant formula, the fat component is present in an amount of from about 10% to about 35%, including from about 22% to about 30%, and including from about 23% to about 28% by weight of the powdered infant formula. The fat may be from any known or otherwise suitable source that is safe and effective for oral administration and is compatible with the essential and other ingredients in the selected product form, including both vegetable and animal sources such as milk fat from bovine, water buffalo, and other mammalian sources. Vegetable sources may include grains such as safflower and canola in addition to vegetable oils such as corn oil, soy oil, coconut oil, palm olein oil, and palm kernel olein oil.

When the powdered nutritional extrusion product is a powdered adult nutritional product, the fat component is present in an amount of from about 0.5% to about 25%, including from about 1% to about 10% and also including from about 2% to about 5% by weight of the powdered adult nutritional product. The fat may be any known or otherwise suitable source that is safe and effective for oral administration and is compatible with the essential and other ingredients in the selected product form.

Suitable fat or fat sources include coconut oil, soy oil, olive oil, high oleic safflower or high oleic sunflower oil, safflower oil, sunflower oil, corn oil, palm olein oil, palm kernel olein oil, canola oil, triheptanoin, milk fat including butter, any animal fat or fraction thereof, phospholipids from milk fat, fish or crustacean oils containing docosahexaenoic acid (DHA), eicosapentaenoic acid (EPA), or both, phospholipids from fish or crustacean, including krill, containing docosahexaenoic acid (DHA), eicosapentaenoic acid (EPA), or both, concentrates of DHA and/or EPA from marine, vegetable, or fugal sources, arachidonic acid (ARA) concentrate from fungal or other sources, a-linolenic acid concentrate (ALA), (flax seed oil, phospholipids and fractions thereof, including soy lecithin and egg lecithin, both partially hydrolyzed and unhydrolyzed, monoglycerides and/or diglycerides or mixtures of mono and diglycerides from both vegetable and animal sources, and plant sterols and compounds containing plant sterols, diacetyl tartaric acid of mono and diglycerides (DATEM) and combinations thereof

Protein

The powdered nutritional products of the present disclosure may comprise a protein or protein source.

When the powdered nutritional product is a powdered infant formula, the protein component is present in an amount of from about 5% to about 45%, including from about 8% to about 25%, and including from about 10% to about 12% by weight of the powdered infant formula. The protein may be any known or otherwise suitable source that is safe and effective for oral administration and is compatible with the essential and other ingredients in the selected product form.

When the powdered nutritional product is a powdered adult nutritional product, the protein component is present in an amount of from about 5 to about 45%, including from about 8% to about 25% and also including from about 15% to about 25% by weight of the powdered adult nutritional product. The protein may be any known or otherwise suitable source that is safe and effective for oral administration and is compatible with the essential and other ingredients in the selected product form.

Suitable protein or protein sources include milk protein derived from bovine, water buffalo or any combination of mammalian source, either intact, partially hydrolyzed, or fully hydrolyzed, or a combination thereof, of lactase treated nonfat dry milk, lactase treated skim milk powder, milk protein isolate, or milk protein concentrate, milk protein isolate, milk protein concentrate, whey protein concentrate, whey protein isolate, glycomacropeptides, caseinates such as sodium caseinate, potassium caseinate, calcium caseinate, magnesium caseinate, or any combination of caseinate salts of any mineral, soy protein concentrate, soy protein isolate, defatted soy protein flour, pea protein isolate, pea protein concentrate, any monocot or dicot protein isolate or protein concentrate, animal collagen, gelatin, all amino acids, taurine, methionine, milk protein peptides, whey protein peptides, lactoferrin (either native or genetically produced), bovine colostrum, human colostrum, other mammalian colostrum, genetic communication proteins found in colostrum and in mammalian milk such as, but not limited to interleukin proteins, hydrolyzed animal collagen, hydrolyzed yeast, and combinations thereof.

Macronutrient Profile

The total amount or concentration of fat, carbohydrate, and protein, in the powdered nutritional products of the present disclosure can vary considerably depending upon the selected formulation and dietary or medical needs of the intended user. Additional suitable examples of macronutrient concentrations, as a percentage of total calories, are set forth in the tables below. In this context, the total amount or concentration refers to all fat, carbohydrate, and protein sources in the powdered product.

For powdered infant formulas, such total amounts or concentrations are most typically and preferably formulated within any of the embodied ranges described in the following table (all numbers have “about” in front of them).

| | Embodiment A | Embodiment B | Embodiment C |
|---|---|---|---|
| Nutrient | (% Calories) | (% Calories) | (% Calories) |
| Carbohydrate | 20-85 | 30-60 | 35-60 |
| Fat | 5-70 | 20-60 | 20-32 |
| Protein | 2-75 | 5-50 | 7-20 |

For powdered adult nutritional products, such total amounts or concentrations are most typically and preferably formulated within any of the embodied ranges described in the following table (all numbers have “about” in front of them).

| | Embodiment A | Embodiment B | Embodiment C |
|---|---|---|---|
| Nutrient | (% Calories) | (% Calories) | (% Calories) |
| Carbohydrate | 1-98 | 10-75 | 30-50 |
| Fat | 1-98 | 12-85 | 15-55 |
| Protein | 1-98 | 5-70 | 15-45 |

Optional Ingredients

The powdered nutritional products of the present disclosure mayfurther comprise other optional components that may modify the physical, chemical, aesthetic or processing characteristics of the products or serve as pharmaceutical or additional nutritional components when used in the targeted population. Many such optional ingredients are known or otherwise suitable for use in medical food or other nutritional products or pharmaceutical dosage forms and may also be used in the formulations herein, provided that such optional ingredients are safe and effective for oral administration and are compatible with the essential and other ingredients in the selected product form.

Non-limiting examples of such optional ingredients include preservatives, anti-oxidants, emulsifying agents, buffers, pharmaceutical actives, additional nutrients as described herein, vitamins, minerals, sweeteners including artificial sweeteners (e.g., saccharine, aspartame, acesulfame, Stevia extract, and sucralose) colorants, flavorants (both natural, artificial, and/or a combination thereof) in addition to those described herein, thickening agents and stabilizers, emulsifying agents, lubricants, probiotics (such as any acidophilous and/or bifidus bacteria, both alive and inactive), prebiotics (as described under carbohydrates including but not limited to galacto-oligsacchardies, fructo-oligsaccharides, any rice, tapioca, and/or corn starch either native or cross-linked, dextrin, vegetable fiber from soy, pea and/or any legume, isomaltulose, sucromalt, tagatose, any gum including vegetable or non-vegetable gum such as xanthan gum, gum Arabic, gum acacia, xanthan gum, gum tragacanth, and/or guar gum or any combination of gums), calcium beta-hydroxy beta-methylbutyrate (11 MB), arginine, glutamine, and so forth.

Non-limiting examples of suitable minerals for use herein include phosphorus, sodium, chloride, magnesium, manganese, iron, copper, zinc, iodine, calcium, potassium, chromium, molybdenum, selenium, and combinations thereof

Non-limiting examples of suitable vitamins for use herein include biotin, choline, inositol, folic acid, pantothenic acid, choline, vitamin A. thiamine (vitamin B₁). riboflavin (vitamin B₂), niacin (vitamin B₃), pyridoxine (vitamin B₆), cyanocobalamine (vitamin B₁₂), ascorbic acid (vitamin C), vitamin D. vitamin E, vitamin, and various salts, esters or other derivatives thereof, and combinations thereof

Non-limiting examples of antioxidants include carotenoids (e.g., beta-carotene, zeaxanthtn, lutein, lycopene and combinations thereof), ascorbyl palmitate, flavinoids, isoflavones, including genistein and daidzein and other phytonutrients.

Manufacture

Extruders are known in the art (see, for example, U.S. Provisional Patent Application 61/393,206, published as International Published Patent Application WO 2012/049253, entitled “Curcuminoid Solid Dispersion Formulation,” published Apr. 19, 2012; and International Published Patent Application WO 2011/159653, entitled “Ultrasonically-Assisted Extrusion Methods For Manufacturing Powdered Nutritional Products,” published Dec. 22, 2011), the disclosures of which are incorporated by reference herein. Any suitable extruder that includes a high shear element, as described herein, may be suitable for use in the present disclosure, including, for example, single screw extruders, twin screw extruders (either co-rotating or counter-rotating), multi screw extruders (i.e. those with 3 or more screws), ring screw extruders, planetary gear extruders, etc. Generally, the extrusion will be carried out at a temperature of at least about 70° C., and including from about 70° C. to about 100° C.

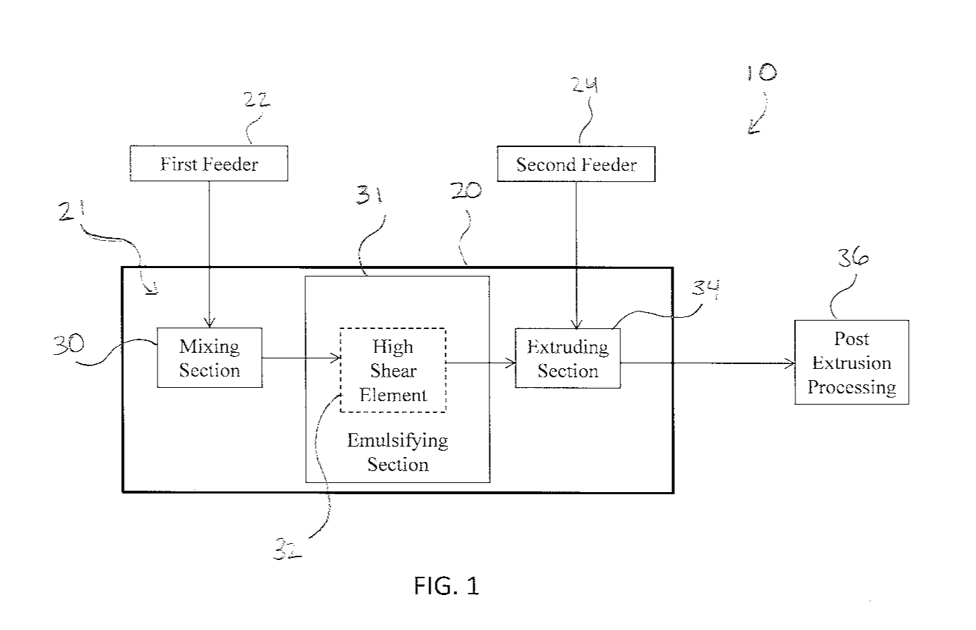

FIG. 1 provides a block diagram of an exemplary extruder (10) that incorporates a high shear element (32). In this embodiment, extruder (10) comprises a barrel (20) with an inner cavity (21), a first feeder (22) and a second feeder (24). Feeders (22, 24) may optionally include one or more stirrers (not shown) within one or both of feeders (22, 24). As shown, extruder (10) includes a mixing section (30), an emulsifying section (31) and an extruding section (34) within extruder barrel (20). Mixing section (30) is configured to mix a first portion of ingredients delivered into inner cavity (21) of barrel (20) via first feeder (22) to create a slurry and may include one or more processing elements mounted on the central shaft(s) of extruder (10). Mixing section (30) may also be configured to convey the slurry downstream within extruder (10) to emulsifying section (31). In preferred embodiments extruder (10) comprises a twin screw extruder, and in even more preferred embodiments, extruder (10) comprises a co-rotating twin screw extruder.

Emulsifying section (31) includes a high shear element (32) that is mounted on the central shaft(s) of the extruder (10) and is configured to emulsify the slurry produced by mixing section (30). In some embodiments, emulsifying section (31) includes two or more high shear elements, although this is not required. In such embodiments, the extruder may include combinations of different types of high shear elements or two or more of the same type of high shear element. In embodiments that include two or more high shear elements, the high shear elements may be positioned successively along the central shaft(s) of the extruder to subject the slurry/emulsion to desired shear rates multiple times. In embodiments that include two or more high shear elements, the high shear elements may have substantially the same configuration or they may have different configurations depending on what configurations are suitable to produce an emulsion of the desired quality for a particular application of a given embodiment. Emulsifying section (31) may also include one or more processing elements mounted on the central shaft(s) of the extruder in addition to high shear element (32), although this is not required. In embodiments where emulsifying section (31) includes one or more processing elements, at least a portion of those elements may be configured to apply a shear rate to the slurry as it travels through emulsifying section (31). Emulsifying section (31) may also be configured to convey the emulsion downstream within extruder (10) to extruding section (34).

Extruding section (34) is configured to combine the emulsion produced by emulsifying section (31) with at least a second portion of ingredients delivered into inner cavity (21) of barrel (20) via second feeder (24) to create an extrudate that can be used to produce a powdered nutritional product. Extruding section (34) may include one or more processing elements mounted on the central shaft(s) of extruder (10). Extruding section (34) may also be configured to convey the extrudate downstream within extruder (10) so that it can be extruded through a die at the end of extruder (10) or as a cake without a die which can be dried by a continuous vacuum belt dryer with or without microwave or radiant options or combinations thereof.

The high shear elements and processing elements discussed above may be mounted to the central shaft(s) of the extruder (10) so that each element rotates uniformly with the respective shaft the element is mounted on.

Feeders (22, 24) may be configured to receive ingredients from one or more input sources in order to allow for continuous processing of the powdered nutritional product. In some embodiments liquid ingredients and powdered ingredients may be mixed together and delivered to the extruder via a single delivery apparatus. Other embodiments may incorporate separate delivery apparatuses for liquid ingredients and for powdered ingredients. In such embodiments powdered ingredients may be delivered through any suitable type of delivery apparatus, including but not limited to gravimetric feeders, volumetric feeders, and/or preconditioners, while the liquid ingredients may be delivered through any suitable type of delivery apparatus, including but not limited to a pump, including but not limited to a gear pump or some other type of positive displacement pump. The separate delivery apparatuses may be arranged so as to deliver the liquid ingredients and powdered ingredients at substantially the same point in the extruder. For example, in such an embodiment, first feeder (22) shown in FIG. 1 may represent two or more separate delivery apparatuses respectively configured to deliver powdered ingredients and liquid ingredients into the mixing section (30), while second feeder 24 shown in FIG. 1 may represent two or more separate delivery apparatuses respectively configured to deliver powdered ingredients and liquid ingredients into the extruding section (34).

In the illustrated embodiment, first feeder (22) is in communication with inner cavity (21) of barrel (20) so that ingredients may be delivered into inner cavity (21). Specifically, first feeder (22) is positioned such that ingredients delivered via first feeder (22) are delivered to mixing section (30) of extruder (10). Mixing section (30) may be configured to create a slurry by mixing, but not emulsifying, a portion of the ingredients required for a powdered nutritional product. Mixing section (30) may provide a substantially homogeneous slurry to emulsifying section (31) and high shear element (32), which may improve the overall quality of the resulting powdered nutritional product. As shown, high shear element (32) is positioned immediately downstream of mixing section (30) such that after ingredients are mixed and the protein is hydrated by mixing section (30), they are then delivered to high shear element (32). The term “downstream,” as used herein, refers to a direction in which the material is being conveyed in the extruder, i.e. the conveying direction.

In this embodiment, second feeder (24) is also in communication with inner cavity (21) of barrel (20) so that ingredients may be delivered into inner cavity (21). Specifically, second feeder (22) is positioned downstream of first feeder (22) such that ingredients delivered via second feeder (24) are delivered to extruding section (34), which is located downstream of high shear element (32). As shown, after ingredients are processed by high shear element (32) to produce an emulsion, the emulsion is delivered to extruding section (34), where the emulsion is combined with ingredients delivered via second feeder (24) to form the extrudate. The extrudate is then processed by extruding section (34). While the illustrated embodiment depicts two feeders, other suitable numbers of feeders, such as three, four, or more may be used depending on the particular application of a given embodiment. The feeders may be positioned anywhere along the length of the extruder from the beginning of the extruder, along the mid-section of the extruder (before and after the introduction of the fat), to just prior to the discharge end of the extruder, provided they allow for the necessary ingredients to be delivered to the appropriate sections and the elements contained therein. Collectively, the mixing section (30), feeders (22, 24), high shear element (32), and extruding section (34) are configured to discharge a substantially homogeneous extrudate from extruder (10).

In one exemplary method of manufacturing a powdered nutritional product using extruder (10), a first portion of ingredients is introduced into mixing section (30) via first feeder (22). The first portion of ingredients is then sufficiently mixed together, but not emulsified, by mixing section (30) to form a slurry. In this embodiment, the first portion of ingredients comprises a combination of dry ingredients and liquid ingredients that produce a slurry. In this embodiment, the first portion of ingredients comprises at least a portion of the fat, at least a portion of the protein, and at least a portion of the water required to produce the desired powdered nutritional product. Water is typically present in the extrudate upon exiting the extruder in an amount of from about 10% to about 25%, or from about 10% to about 20%, or from about 10% to about 15% by weight of all of the raw materials for the desired powdered nutritional product.

For example, the first portion of ingredients may comprise up to about 100% of the total amount of fat and fat soluble vitamins and other hydrophobic nutrients required for the desired powdered nutritional product, a portion of the total amount of protein required for the desired powdered nutritional product that is less than 100% of the total amount of protein required but an amount that is sufficient to fully emulsify the fat, and up to about 100% of the total amount of water required for the desired powdered nutritional product. Including a portion of the total amount of protein required that is less than 100% of the total amount of protein required but is also sufficient to fully emulsify the fat. The first portion of ingredients may also comprise fat soluble vitamins and other hydrophobic nutrients (e.g., vitamin A, vitamin E including vitamin E succinate, vitamin D3, vitamin D2, tocotrienols, carotenoids including but limited to lutein, beta-carotene, zeathanthin, and lycopene, curcuminoids, and long-chain unsaturated fatty acids including DHA and EPA and ARA, mono and diglycerides and combinations thereof).

Either before or during the mixing step, but prior to emulsification, it may be beneficial to fully hydrate the protein included within the first portion of ingredients. The protein may be fully hydrated using standard means known within the food preparation industry. Hydration of the protein may take place either inside or outside of the extruder and may be performed either in a batch kettle or by continuously running the protein and other necessary ingredients through a device configured to aid in hydration, such as a shear pump or a preconditioner, which may be used in combination with an extruder when a high level of mixing energy is required. For example, it may be beneficial to use a preconditioner to achieve protein hydration to reduce the amount of time required to achieve the desired hydration. Hydration of the protein may also be achieved within the extruder through the selection of various extruder element designs, such as processing elements. By way of example only, each of these extruder elements may include one or more rows of teeth designed to provide an increased shear rate.

As shown in FIG. 1, after the first portion of ingredients is mixed together in mixing section (30) to produce a slurry, then that slurry is delivered to emulsifying section (31) and processed by high shear element (32). The slurry may be delivered to high shear element (32) through any suitable type of delivery apparatus, including but not limited to a pump (such as a gear pump or some other type of positive displacement pump), one or more conveying elements mounted on the central shaft(s) of extruder (10) (the number, type and configuration of which may be chosen to achieve sufficient pressure to deliver the slurry to and through high shear element (32)), and combinations thereof. Specifically, high shear element (32) emulsifies the slurry by subjecting the slurry to a shear rate and elongational flow sufficient to produce a sufficiently stable emulsion. In some embodiments, the shear rate may depend on, among other factors, the diameter of the high shear element (32) which may depend on the diameter of the inner cavity (21) of extruder barrel (20) and may range from about 30 sec′ to about 2,500 sec⁻¹, and preferably at least 100 sec⁻¹. In some embodiments, to satisfactorily emulsify the slurry, high shear element (32) may be configured to subject at least 50% of the slurry to the desired shear rate, preferably at least 75% of the slurry is subjected to the desired shear rate, more preferably at least 90% of the slurry is subjected to the desired shear rate, and even more preferably at least 99% of the slurry is subjected to the desired shear rate. High shear element (32) may comprise any suitable element configured to provide the necessary shear rate, including but not limited to a shearing disc or pair of corresponding shearing discs mounted to the central shaft(s) of the extruder as described in more detail below. In some embodiments, the high shear element (32) may be designed to produce the desired shear rate by increasing the velocity of the slurry by reducing the cross-sectional flow area, such as with orifices or other restricted cross-section flow area designs.

According to the embodiment shown in FIG. 1, after the slurry comprising the first portion of ingredients is emulsified by high shear element (32) it is delivered to extruding section (34), where the slurry is combined with a second portion of ingredients introduced to extruder barrel (20) via second feeder (24). The second portion of ingredients may include both additional powdered ingredients and additional liquid ingredients. In some embodiments, the powdered ingredients may be delivered via one or more volumetric or gravimetric feeders and/or preconditioners, and the additional liquid ingredients may be delivered via one or more pumps (including but not limited to a gear pump or some other type of positive displacement pump). The additional liquid ingredients may include, but are not limited to, corn syrup, galcto-oligosaccaride (GOS) syrup, and fructo-oligosaccharide (FOS) syrup. As shown in FIG. 1, second feeder (24) is positioned downstream of high shear element (32). The second portion of ingredients may include the remaining ingredients (e.g. protein, carbohydrate, fat, minerals, vitamins, and other nutrients, etc.) required to produce the desired powdered nutritional product, or some portion thereof. In some embodiments, less than all of the remaining ingredients may be added to extruding section (34) of extruder (10). In these embodiments, some ingredients, such as for example probiotics, may be added to the extrudate produced by extruder (10) in the post extrusion processing step (36). The combined emulsion and second portion of ingredients are then extruded by extruding section (34) to form a flat sheet, strands, pellets, or other form capable of being dried using conventional drying techniques and equipment, including but not limited to a continuous dryer such as a vacuum belt dryer. Extruding section (34) is discussed in more detail below. Following drying, the extrudate may be ground to the desired size using conventional grinding means, such as one or more FitzMills, Co-Mills, air impact mills (nitrogen or carbon dioxide may be used instead of air in these mills because some ingredients in the extrudate, such as the fats, may be sensitive to oxidation), or other piece(s) of particle sizing equipment. These types of post extrusion processing steps are generally indicated by the Post Extrusion Processing step (36) in FIG. 1. Possible post extrusion processing steps are discussed in more detail below.

In some embodiments, the desired powdered nutritional product may be produced after a single pass through extruder (10). In other embodiments, the desired powdered nutritional product may be a multiply extruded product; that is, the ultimate product may be passed through extruder (10) two, three, four or more times, with additional ingredients being added prior to each successive extrusion. Alternatively, as mentioned above, the extrudate from extruder (10) may be passed through another extruder that may or may not include a high shear element and/or combined with additional ingredients after exiting extruder (10) in order to produce the desired powdered nutritional product.

It may be desirable to establish constant flow rates for all of the ingredients being introduced into various components of extruder (10) to produce a substantially homogeneous extrudate. For example, it may be desirable to establish constant flow rates for the liquid ingredients being delivered to the mixing section (30) to form the slurry, for the slurry being delivered to the emulsifying section (31)/high shear element (32), and for the emulsion and the additional ingredients being delivered to the extruding section (34). In some preferred embodiments, the flow rates of the ingredients can be controlled with flow meters (not shown), including but not limited to volumetric flow meters and gravimetric flow meters. As will be recognized by one skilled in the art based on the disclosure herein, process parameters, including but not limited to the volume (i.e. the flow rate) of the slurry being fed into the emulsifying section (31)/high shear element (32), the volume of the emulsion being fed into the extruding section (34) for extrusion, and the time of exposure of the slurry to the high shear rate, may be considered and adjusted in order to make the process suitable for scalability and reproducibility.

As noted above, it may be generally desirable to maintain a constant flow rate of the slurry into emulsifying section (31)/high shear element (32). The slurry may be delivered into emulsifying section (31)/high shear element (32) at a flow rate suitable to allow high shear element (32) to subject the slurry to the desired shear rate. A constant flow rate and a consistent application of a high shear rate may allow for the intensity of the processing of a given amount of slurry to remain consistent such that reproducible samples can be produced and scaled as desired. The flowrates may be set based upon the rated capacity of the particular extruder being used in a particular application of a given embodiment.

In alternate embodiments (not shown), instead of having a single feeder downstream of high shear element (32) (i.e. second feeder (24) shown in FIG. 1 and described above), the extruder may include multiple downstream feeders to allow the remaining ingredients or some portion thereof (i.e. the ingredients of the powdered nutritional product other than those included in the first portion of ingredients used to form the emulsion) to be delivered at different points along extruding section (34). In such an embodiment, one of the downstream feeders may still be positioned at the beginning of extruding section (34), similar to second feeder (24) described above, so that at least a portion of the remaining ingredients can be combined with the emulsion at the beginning of extruding section (34). By way of example only, additional protein, carbohydrate, fiber, and other powdered ingredients may be delivered via one or more downstream feeders. In some embodiments, the production efficiency may be improved by delivering the main dry ingredients, such as proteins and carbohydrates, through their own individual feeders rather than blending dry ingredients together and then feeding the blended ingredients into the extruder together.

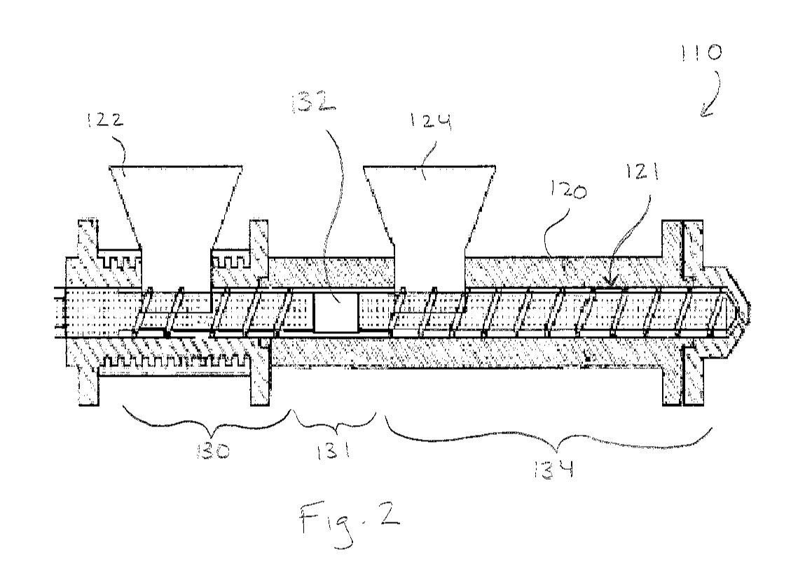

FIG. 2 depicts a particular embodiment of extruder (10), wherein the extruder is a single-screw extruder. For clarity, the extruder in FIG. 2 is identified herein as extruder (110). Extruder (110) comprises a barrel (120) with an inner cavity (121), a first feeder (122) and a second feeder (124). As shown, extruder (110) includes a mixing section (130), an emulsifying section (131), and an extruding section (134) within extruder barrel (120). It should be noted that high shear element (132) is shown schematically in FIG. 2. It should also be noted that feeders (122, 124) and the elements mounted on the central shaft of extruder (110) (e.g., processing elements) are shown generically in FIG. 2 and the exact number, size, configuration arrangement and other suitable parameters of those components will be selected based on the requirements of a particular application of a given embodiment.

Similar to mixing section (30) described above, mixing section (130) is configured to mix a first portion of ingredients delivered into inner cavity (121) of barrel (120) via first feeder (122) to create a slurry and may include one or more processing elements mounted on the central shaft of extruder (110). Mixing section (130) may also be configured to convey the slurry downstream within extruder (110) to emulsifying section (131).

Similar to emulsifying section (31) described above, emulsifying section (131) includes a high shear element (132) that is mounted on the central shaft of the extruder (110) and is configured to emulsify the slurry produced by mixing section (130). In some embodiments, emulsifying section (131) includes two or more high shear elements, although this is not required. In such embodiments, the extruder may include combinations of different types of high shear elements or two or more of the same type of high shear element. In embodiments that include two or more high shear elements, the high shear elements may be positioned successively along the central shaft(s) of the extruder in order to subject the slurry/emulsion to desired shear rates multiple times. In embodiments that include two or more high shear elements, the high shear elements may have substantially the same configuration or they may have different configurations depending on what configurations are suitable to produce an emulsion of the desired quality for a particular application of a given embodiment. Emulsifying section (131) may also include one or more processing elements mounted on the central shaft of the extruder in addition to high shear element (132), although this is not required. In embodiments where emulsifying section (131) includes one or more processing elements, at least a portion of those elements may be configured to apply a shear rate to the slurry as it travels through emulsifying section (131). Emulsifying section (131) may also be configured to convey the emulsion downstream within extruder (110) to extruding section (134).

Similar to extruding section (34) described above, extruding section (134) is configured to combine the emulsion produced by emulsifying section (131) with at least a second portion of ingredients delivered into inner cavity (121) of barrel (120) via second feeder (124) to create an extrudate that can be used to produce a powdered nutritional product. Extruding section (134) may include one or more processing elements mounted on the central shaft of extruder (110). Extruding section (134) may also be configured to convey the extrudate downstream within extruder (110) so that it can be extruded through a die at the end of extruder (110) or as a cake without a die which can be dried by a continuous vacuum belt dryer with or without microwave or radiant options or combinations thereof.

The high shear elements and processing elements discussed above may be mounted to the central shaft of the extruder (110) so that each element rotates uniformly with the shaft.

In the illustrated embodiment, first feeder (122) is in communication with inner cavity (121) of barrel (120) so that ingredients may be delivered into inner cavity (121). Specifically, first feeder (122) is positioned such that ingredients delivered via first feeder (122) are delivered to mixing section (130) of extruder (110). As discussed above, first feeder (122) may include two or more separate delivery apparatuses respectively configured to deliver powdered ingredients and liquid ingredients, although this is not necessarily required. Mixing section (130) may be configured to create a slurry by mixing, but not emulsifying, a portion of the ingredients required for a powdered nutritional product. Mixing section (130) may provide a substantially homogeneous slurry to emulsifying section (131) and high shear element (132), which may improve the overall quality of the resulting powdered nutritional product. As shown, emulsifying section (131) and high shear element (132) are positioned immediately downstream of mixing section (130) such that after ingredients are mixed and the protein is hydrated by mixing section (130), they are then delivered to emulsifying section (131) and high shear element (130). Mixing section (130) may be positioned at or adjacent to the front of barrel (120) (i.e. the end of barrel (120) opposite from the end of barrel (120) where the extrudate is discharged).

In this embodiment, second feeder (124) is also in communication with inner cavity (121) of barrel (120) so that ingredients may be delivered into inner cavity (121). Specifically, second feeder (122) is positioned downstream of first feeder (122) such that ingredients delivered via second feeder (124) are delivered to extruding section (134), which is located downstream of emulsifying section (131) and high shear element (132). As discussed above, second feeder (124) may include two or more separate delivery apparatuses respectively configured to deliver powdered ingredients and liquid ingredients, although this is not necessarily required, As shown, after ingredients are processed by high shear element (132) to produce an emulsion, the emulsion is delivered to extruding section (134), where the emulsion is combined with ingredients delivered via second feeder (124) to form the extrudate. The extrudate is then extruded by the processing elements mounted on the central shaft of extruder (110) in extruding section (134). While the illustrated embodiment depicts two feeders, other suitable numbers of feeders, such as three, four, or more may be used depending on the particular application of a given embodiment.

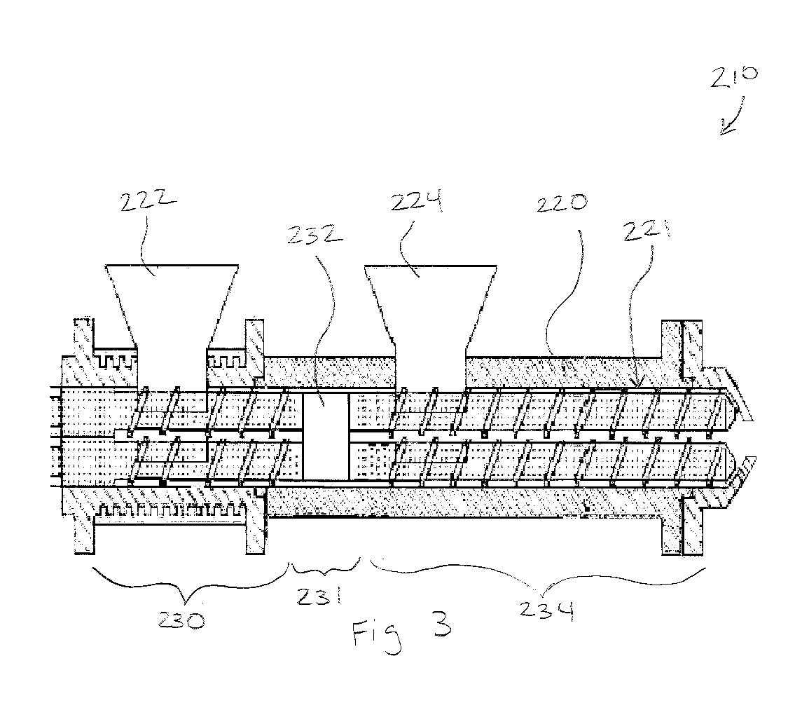

FIG. 3 depicts another particular embodiment of extruder (10), wherein the extruder is a twin screw extruder, such as a co-rotating twin screw extruder or a counter-rotating twin screw extruder. For clarity, the extruder in FIG. 3 is identified herein as extruder (210). Extruder (210) comprises a barrel (220) with an inner cavity (221), a first feeder (222) and a second feeder (224). As shown, extruder (210) includes a mixing section (230), an emulsifying section (231), and an extruding section (234) within extruder barrel (220). It should be noted that high shear element (232) is shown schematically in FIG. 3. It should also be noted that feeders (222, 224) and the elements mounted on the central shafts of extruder (210) (e.g., processing elements) are shown generically in FIG. 3 and the exact number, size, configuration arrangement and other suitable parameters of those components will be selected based on the requirements of a particular application of a given embodiment.

Similar to mixing sections (30, 130) described above, mixing section (230) is configured to mix a first portion of ingredients delivered into inner cavity (221) of barrel (220) via first feeder (222) to create a slurry and may include one or more processing elements mounted on the central shafts of extruder (210). Mixing section (230) may also be configured to convey the slurry downstream within extruder (210) to emulsifying section (231).

Similar to emulsifying sections (31, 131) described above, emulsifying section (231) includes a high shear element (232) that may be mounted on at least one of the central shafts of the extruder (210) and is configured to emulsify the slurry produced by mixing section (230). In embodiments such as the one shown in FIG. 3, where the extruder includes two or more central shafts, the high shear element may comprise a plurality of elements respectively mounted on each one of the central shafts of the extruder. By way of example only, in an embodiment where the extruder is a twin screw extruder, the high shear element may comprise a pair of corresponding elements that are each mounted to a respective central shaft. Those elements may be positioned substantially adjacent to each other or have any other arrangement suitable to create an emulsion having the desired qualities. In such an embodiment, the pair of elements may each have substantially identical configurations or the pair of elements may have different but complementary configurations suitable to create an emulsion having the desired qualities. In some embodiments emulsifying section (231) includes two or more high shear elements, although this is not required. In such embodiments, the extruder may include combinations of different types of high shear elements or two or more of the same type of high shear element. In embodiments that include two or more high shear elements, the high shear elements may be positioned successively along the central shaft(s) of the extruder in order to subject the slurry/emulsion to desired shear rates multiple times. By way of example only, in embodiments where the extruder is a twin screw extruder, the high shear element may comprise a first pair of elements respectively mounted on each of the central shafts and a second pair of elements respectively mounted on each of the central shafts downstream of the first pair of elements. In embodiments that include two or more high shear elements, the high shear elements may have substantially the same configuration or they may have different configurations depending on what configurations are suitable to produce an emulsion of the desired quality for a particular application of a given embodiment. Emulsifying section (231) may also include one or more processing elements mounted on the central shafts in addition to high shear element (232), although this is not required. In embodiments where emulsifying section (231) includes one or more processing elements, at least a portion of those elements may be configured to apply a shear rate to the slurry as it travels through emulsifying section (231). Emulsifying section (231) may also be configured to convey the emulsion downstream within extruder (210) to extruding section (234).

Similar to extruding sections (34, 134) described above, extruding section (234) is configured to combine the emulsion produced by emulsifying section (231) with at least a second portion of ingredients delivered into inner cavity (221) of barrel (220) via second feeder (224) to create an extrudate that can be used to produce a powdered nutritional product. Extruding section (234) may include one or more processing elements mounted on the central shafts of extruder (210). Extruding section (234) may also be configured to convey the extrudate downstream within extruder (210) so that it can be extruded through a die at the end of extruder (210) or as a cake without a die which can be dried by a continuous vacuum belt dryer with or without microwave or radiant options or combinations thereof.

The high shear elements and processing elements discussed above may be mounted to the central shafts of the extruder (210) so that each element rotates uniformly with the respective shaft the element is mounted on.

In the illustrated embodiment, first feeder (222) is in communication with inner cavity (221) of barrel (220) so that ingredients may be delivered into inner cavity (221). Specifically, first feeder (222) is positioned such that ingredients delivered via first feeder (222) are delivered to mixing section (230) of extruder (210). As discussed above, first feeder (222) may include two or more separate delivery apparatuses respectively configured to deliver powdered ingredients and liquid ingredients, although this is not necessarily required. Mixing section (230) may be configured to create a slurry by mixing, but not emulsifying, a portion of the ingredients required for a powdered nutritional product. Mixing section (230) may provide a substantially homogeneous slurry to emulsifying section (231) and high shear element (232), which may improve the overall quality of the resulting powdered nutritional product. As shown, high shear element (232) is positioned immediately downstream of mixing section (230) such that after ingredients are mixed and the protein is hydrated by mixing section (230), they are then delivered to high shear element (230). Mixing section (230) may be positioned at or adjacent to the front of barrel (220) (i.e. the end of barrel (220) opposite from the end of barrel (220) where the extrudate is discharged).

In this embodiment, second feeder (224) is also in communication with inner cavity (221) of barrel (220) so that ingredients may be delivered into inner cavity (221). Specifically, second feeder (222) is positioned downstream of first feeder (222) such that ingredients delivered via second feeder (224) are delivered to extruding section (234), which is located downstream of emulsifying section (231) and high shear element (232). As discussed above, second feeder (224) may include two or more separate delivery apparatuses respectively configured to deliver powdered ingredients and liquid ingredients, although this is not necessarily required. As shown, after ingredients are processed by high shear element (232) to produce an emulsion, the emulsion is delivered to extruding section (234), where the emulsion is combined with ingredients delivered via second feeder (224) to form the extrudate. The extrudate is then extruded by the processing elements mounted on the central shafts of extruder (210) in extruding section (234). While the illustrated embodiment depicts two feeders, other suitable numbers of feeders, such as three, four, or more may be used depending on the particular application of a given embodiment.

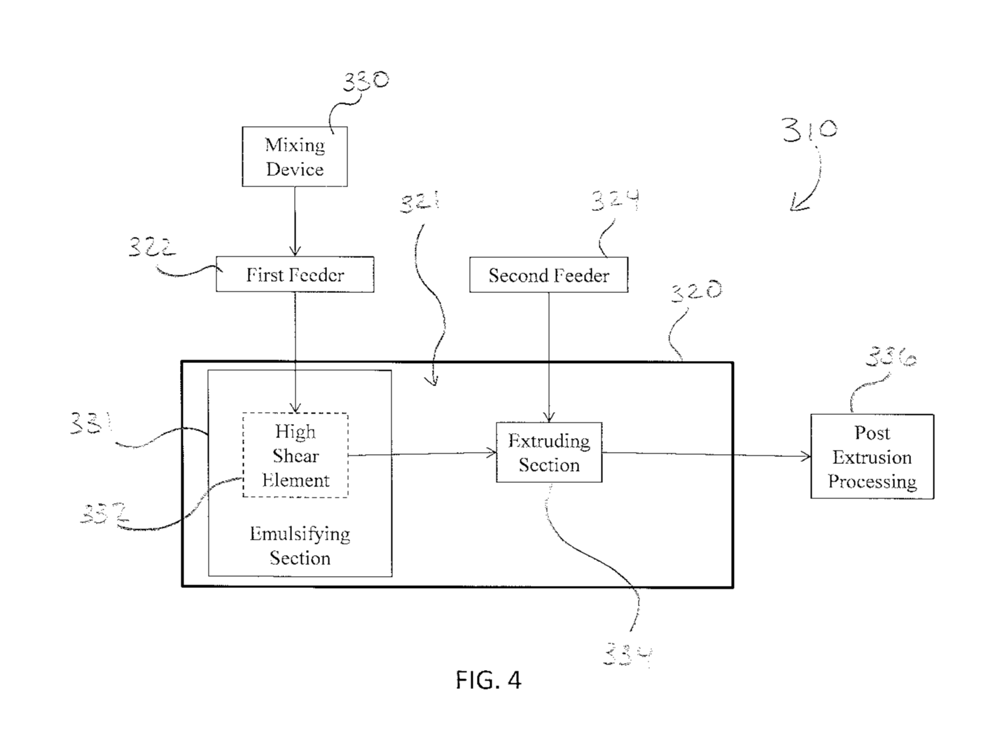

FIG. 4 provides a block diagram of an alternate exemplary extruder (310) that incorporates a high shear element (332). In this embodiment, extruder (310) comprises a barrel (320) with an inner cavity (321), a first feeder (322) and a second feeder (324). Feeders (322, 324) may optionally include one or more stirrers (not shown) within one or both of feeders (322, 324). As shown, extruder (310) includes a mixing element (330), an emulsifying section (331) and an extruding section (334) within extruder barrel (320). Unlike extruder (10) shown in FIG. 1 and described above where the slurry is created within extruder barrel (20) by mixing section (30), in extruder (310) shown in FIG. 4, the slurry is created outside of extruder barrel (320) by mixing device (330) and then delivered via first feeder (322) to emulsifying section (331) inside internal cavity (321) of extruder barrel (320). In preferred embodiments extruder (310) comprises a twin screw extruder, and in even more preferred embodiments, extruder (310) comprises a co-rotating twin screw extruder.

Similar to emulsifying sections (31, 131, 231) described above, emulsifying section (331) includes a high shear element (332) that is mounted on the central shaft(s) of the extruder (310) and is configured to emulsify the slurry produced by mixing device (330). In some embodiments, emulsifying section (331) includes two or more high shear elements, although this is not required. In such embodiments, the extruder may include combinations of different types of high shear elements or two or more of the same type of high shear element. In embodiments that include two or more high shear elements, the high shear elements may be positioned successively along the central shaft(s) of the extruder in order to subject the slurry/emulsion to desired shear rates multiple times. In embodiments that include two or more high shear elements, the high shear elements may have substantially the same configuration or they may have different configurations depending on what configurations are suitable to produce an emulsion of the desired quality for a particular application of a given embodiment. Emulsifying section (331) may also include one or more processing elements mounted on the central shaft(s) of the extruder in addition to high shear element (332), although this is not required. In embodiments where emulsifying section (331) includes one or more processing elements, at least a portion of those elements may be configured to apply a shear rate to the slurry as it travels through emulsifying section (331). Emulsifying section (331) may also be configured to convey the emulsion downstream within extruder (310) to extruding section (334).

Similar to extruding sections (34, 134, 234) described above, extruding section (334) is configured to combine the emulsion produced by emulsifying section (331) with at least a second portion of ingredients delivered into inner cavity (321) of barrel (320) via second feeder (324) to create an extrudate that can be used to produce a powdered nutritional product. Extruding section (334) may include one or more processing elements mounted on the central shaft(s) of extruder (310). Extruding section (334) may also be configured to convey the extrudate downstream within extruder (310) so that it can be extruded through a die at the end of extruder (310) or as a cake without a die which can be dried by a continuous vacuum belt dryer with or without microwave or radiant options or combinations thereof.

The high shear elements and processing elements discussed above may be mounted to the central shaft(s) of the extruder (310) so that each element rotates uniformly with the respective shaft the element is mounted on.

Feeders (322, 324) may be configured to receive ingredients from one or more input sources in order to allow for continuous processing of the powdered nutritional product. In some embodiments, liquid ingredients and powdered ingredients may be mixed together and delivered to the extruder via a single delivery apparatus. Other embodiments may incorporate separate delivery apparatuses for liquid ingredients and for powdered ingredients. In such embodiments powdered ingredients may be delivered through any suitable type of delivery apparatus, including but not limited to gravimetric feeders, volumetric feeders, and/or preconditioners, while the liquid ingredients may be delivered through any suitable type of delivery apparatus, including but not limited to a pump, including but not limited to a gear pump or some other type of positive displacement pump. The separate delivery apparatuses may be arranged so as to deliver the liquid ingredients and powdered ingredients at substantially the same point in the extruder. For example, in such an embodiment, first feeder (22) shown in FIG. 1 may represent two or more separate delivery apparatuses respectively configured to deliver powdered ingredients and liquid ingredients into the mixing section (30), while second feeder 24 shown in FIG. 1 may represent two or more separate delivery apparatuses respectively configured to deliver powdered ingredients and liquid ingredients into the extruding section (34).

In the illustrated embodiment, mixing device (330) is configured to create a shiny by mixing, but not emulsifying, at least a portion of the ingredients required to make a desired powdered nutritional product. Mixing device (330) may provide a substantially homogeneous slurry to emulsifying section (331) and high shear element (332), which may improve the overall quality of the resulting powdered nutritional product. Mixing device (330) may comprise one or more preconditioners, batching tanks, static mixers, in-line mixers, or any other mechanical device configured to produce the desired slurry. As shown, mixing device (330) is in communication with first feeder (322) in order to allow the slurry to be delivered from mixing device into the inner cavity (321) of barrel (320) via first feeder (322). Specifically, first feeder (322) is positioned such that the ingredients delivered via first feeder (322), including but not limited to the slurry from the mixing device (330), are delivered to emulsifying section and high shear element (332). As discussed above, first feeder (322) may include two or more separate delivery apparatuses respectively configured to deliver powdered ingredients and liquid ingredients, although this is not necessarily required. It will be appreciated that first feeder (322) may be configured to receive ingredients from one or more input sources in addition to mixing device (330). For example, feeder (322) may receive powdered ingredients from a preconditioner that may include a mass or flow controller.

In this embodiment, second feeder (324) is also in communication with inner cavity (321) of barrel (320) so that ingredients may be delivered into inner cavity (321). Similar to first feeder (322), second feeder (324) may also receive powdered ingredients from a preconditioner that may include a mass or flow controller. Specifically, second feeder (324) is positioned downstream of first feeder (322) such that ingredients delivered via second feeder (324) are delivered to extruding section (334), which is located downstream of high shear element (332). As discussed above, second feeder (324) may include two or more separate delivery apparatuses respectively configured to deliver powdered ingredients and liquid ingredients, although this is not necessarily required. As shown, after ingredients are processed by high shear element (332) to produce an emulsion, the emulsion is delivered to extruding section (334), where the emulsion is combined with ingredients delivered via second feeder (324) to form the extrudate. The extrudate is then processed by extruding section (334). While the illustrated embodiment depicts two feeders, other suitable numbers of feeders, such as three, four, or more may be used depending on the particular application of a given embodiment. The feeders may be positioned anywhere along the length of the extruder from the beginning of the extruder, along the mid-section of the extruder (before and after the introduction of the fat), to just prior to the discharge end of the extruder, provided they allow for the necessary ingredients to be delivered to the appropriate sections and the elements contained therein. Collectively, the mixing device (330), feeders (322, 324), emulsifying section (331), high shear element (332), and extruding section (334) may be configured to discharge a substantially homogeneous extrudate from extruder (310).

For example, the first portion of ingredients may comprise up to about 100% of the total amount of fat and fat soluble vitamins and other hydrophobic nutrients required for the desired powdered nutritional product, a portion of the total amount of protein required for the desired powdered nutritional product that is less than 100% of the total amount of protein required but an amount that is sufficient to fully emulsify the fat, and up to about 100% of the total amount of water required for the desired powdered nutritional product. Including a portion of the total amount of protein required that is less than 100% of the total amount of protein required but is also sufficient to fully emulsify the fat, may result in a slurry with a modified viscosity. The first portion of ingredients may also comprise fat soluble vitamins and other hydrophobic nutrients (e.g., vitamin A, vitamin E including vitamin E succinate, vitamin D3, vitamin D2, tocotrienols, carotenoids including but limited to lutein, beta-carotene, zeathanthin, and lycopene, curcuminoids, and long-chain unsaturated fatty acids including DHA and EPA and ARA, mono and diglycerides and combinations thereof).

As discussed above, either before or during the mixing step, but prior to emulsification, it may be beneficial to fully hydrate the protein included within the first portion of ingredients. The protein may be fully hydrated using standard means known within the food preparation industry. Hydration of the protein may take place either inside or outside of the extruder and may be performed either in a batch kettle or by continuously running the protein and other necessary ingredients through a device configured to aid in hydration, such as a shear pump or a preconditioner. For example, it may be beneficial to use a preconditioner to achieve protein hydration to reduce the amount of time required to achieve the desired hydration.

As shown in FIG. 4, after the first portion of ingredients is mixed together in mixing device (330) to produce a slurry, then that slurry is delivered via first feeder (322) to emulsifying section (331) and processed by high shear element (332). The slurry may be delivered to high shear element (332) through any suitable type of delivery apparatus, including but not limited to a pump, (such as a gear pump or some other type of positive displacement pump), one or more conveying elements mounted on the central shaft(s) of extruder (310) (the number, type and configuration of which may be chosen to achieve sufficient pressure to deliver the slurry to and through high shear element (332)), and combinations thereof. Specifically, high shear element (332) emulsifies the slurry by subjecting the slurry to a high shear rate and elongational flow sufficient to produce a sufficiently stable emulsion. In some embodiments, the shear rate may depend on, among other factors, the diameter of the inner cavity (321) of extruder barrel (320) and may range from about 30 sec⁻¹ to about 2,500 sec⁻¹, and preferably at least 100 sec⁻¹. In some embodiments, in order to satisfactorily emulsify the slurry, high shear element (332) may be configured to subject at least 50% of the slurry to the desired shear rate, preferably at least 75% of the slurry is subjected to the desired shear rate, more preferably at least 90% of the slurry is subjected to the desired shear rate, and even more preferably at least 99% of the slurry is subjected to the desired shear rate. High shear element (332) may comprise any suitable element configured to provide the necessary shear rate, including but not limited to a shearing disc or pair of corresponding shearing discs mounted to the central shaft(s) of the extruder as described in more detail below. In some embodiments, the high shear element (332) may be designed to produce the desired shear rate by increasing the velocity of the slurry by reducing the cross-sectional flow area, such as with orifices or other restricted cross-section flow area designs.

According to the embodiment shown in FIG. 4, after the slurry comprising the first portion of ingredients is emulsified by high shear element (332) it is delivered to extruding section (334), where the slurry is combined with a second portion of ingredients introduced to extruder barrel (320) via second feeder (324). The second portion of ingredients may include both additional powdered ingredients and additional liquid ingredients. In some embodiments, the powdered ingredients may be delivered via one or more volumetric or gravimetric feeders and/or preconditioners, and the additional liquid ingredients may be delivered via one or more pumps (including but not limited to a gear pump or some other type of positive displacement pump). The additional liquid ingredients may include, but are not limited to, corn syrup, galcto-oligosaccaride (GOS) syrup, and fructo-oligosaccharide (FOS) syrup. As shown in FIG. 4, second feeder (324) is positioned downstream of high shear element (332). The second portion of ingredients may include the remaining ingredients (e.g. protein, carbohydrate, fat, minerals, vitamins, and other nutrients, etc.) required to produce the desired powdered nutritional product, or some portion thereof. In some embodiments, less than all of the remaining ingredients may be added to extruding section (334) of extruder (310). In these embodiments, some ingredients, such as for example probiotics, may be added to the extrudate produced by extruder (310) in the post extrusion processing step (336). The combined emulsion and second portion of ingredients are then extruded by extruding section (334) to form a flat sheet, strands, pellets, or other form capable of being dried using conventional drying techniques and equipment, including but not limited to a continuous dryer such as a continuous vacuum belt dryer with or without microwave or radiant options or combinations thereof. Extruding section (334) is discussed in more detail below. Following drying, the extrudate may be ground to the desired size using conventional grinding means, such as one or more Fitzmills, Co-Mills, air impact mills (nitrogen may be used instead of air in these mills because some ingredients in the extrudate such as the fats, may be sensitive to oxidation), or other piece(s) of particle sizing equipment. These types of post extrusion processing steps are generally indicated by the Post Extrusion Processing step (336) in FIG. 4. Possible post extrusion processing steps are discussed in more detail below.

In some embodiments, the desired powdered nutritional product may be produced after a single pass through extruder (310). In other embodiments, the desired powdered nutritional product may be a multiply extruded product; that is, the ultimate product may be passed through extruder (310) two, three, four or more times, with additional ingredients being added prior to each successive extrusion. Alternatively, as mentioned above, the extrudate from extruder (310) may be passed through another extruder that may or may not include a high shear element and/or combined with additional ingredients after exiting extruder (310) in order to produce the desired powdered nutritional product.

As discussed above with regard to extruder (10) shown in FIG. 1, it may be desirable to establish constant flow rates for all of the ingredients being introduced into the various components of extruder (310). Because it was already addressed above, the discussion regarding flow rates will not be repeated here.

In alternate embodiments (not shown), instead of having a single feeder downstream of high shear element (332) (i.e. second feeder (324) shown in FIG. 4 and described above), the extruder may include multiple downstream feeders in order to allow the remaining ingredients or some portion thereof (i.e. the ingredients of the powdered nutritional product other than those included in the first portion of ingredients used to form the emulsion) to be delivered at different points along extruding section (334). In such an embodiment, one of the downstream feeders may still be positioned at the beginning of extruding section (34), similar to second feeder (324) described above, so that at least a portion of the remaining ingredients can be combined with the emulsion at the beginning of extruding section (334). By way of example only, additional protein, carbohydrate, fiber, and other powdered ingredients may be delivered via one or more downstream feeders. In some embodiments, the production efficiency may be improved by delivering the main dry ingredients, such as proteins and carbohydrates, through their own individual feeders rather than blending dry ingredients together and then feeding the blended ingredients into the extruder together.

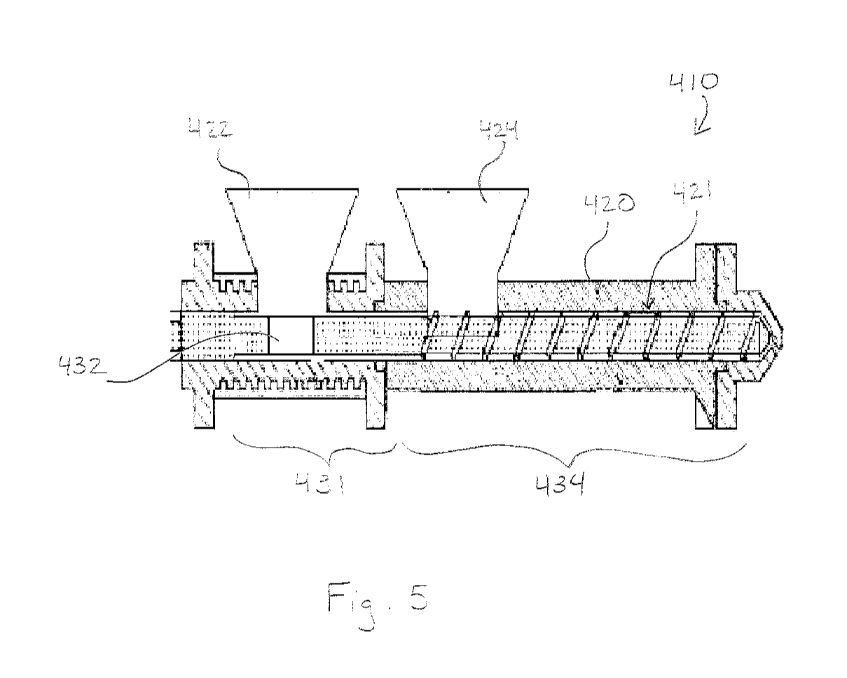

FIG. 5 depicts a particular embodiment of extruder (310) wherein the extruder is a single-screw extruder. For clarity, the extruder in FIG. 5 is identified herein as extruder (410). Extruder (410) comprises a barrel (420) with an inner cavity (421), a first feeder (422) and a second feeder (424). As shown, extruder (410) includes an emulsifying section (431) and an extruding section (434) within extruder barrel (420). Similar to extruder (310) described above, in this embodiment, a mixing device (not shown) is positioned external to barrel (420) of extruder (410) that is configured to create a slurry by mixing, but not emulsifying, at least a portion of the ingredients required for a desired powdered nutritional product. It should be noted that high shear element (432) is shown schematically in FIG. 5. It should also be noted that feeders (422, 424) and the elements mounted on the central shaft of extruder (410) (e.g., processing elements) are shown generically in FIG. 5 and the exact number, size, configuration arrangement and other suitable parameters of those components will be selected based on the requirements of a particular application of a given embodiment.

Similar to mixing device (330) describe above, a mixing device (not shown) may be configured to mix a first portion of ingredients to create a slurry outside of extruder barrel (420). The slurry is then delivered via first feeder (422) to emulsifying section (431) inside internal cavity (421) of extruder barrel (420). The mixing device (not shown) may provide a substantially homogeneous slurry to emulsifying section (431) and high shear element (432), which may improve the overall quality of the resulting powdered nutritional product.

Similar to emulsifying sections (31, 131, 231, 331) described above, emulsifying section (431) includes a high shear element (432) that is mounted on the central shaft of the extruder (410) and is configured to emulsify a slurry. However, in this embodiment the slurry is produced by a mixing device (not shown) external to extruder (410) rather than a mixing section located within the extruder, as with extruders (10, 110, 210) described above. In some embodiments, emulsifying section (431) includes two or more high shear elements, although this is not required. In such embodiments, the extruder may include combinations of different types of high shear elements or two or more of the same type of high shear element. In embodiments that include two or more high shear elements, the high shear elements may be positioned successively along the central shaft(s) of the extruder to subject the slurry/emulsion to desired shear rates multiple times. In embodiments that include two or more high shear elements, the high shear elements may have substantially the same configuration or they may have different configurations depending on what configurations are suitable to produce an emulsion of the desired quality for a particular application of a given embodiment. Emulsifying section (431) may also include one or more processing elements mounted on the central shaft of the extruder in addition to high shear element (432), although this is not required. In embodiments where emulsifying section (431) includes one or more processing elements, at least a portion of those elements may be configured to apply a shear rate to the slurry as it travels through emulsifying section (431). Emulsifying section (431) may also be configured to convey the emulsion downstream within extruder (410) to extruding section (434).

Similar to extruding sections (34, 134, 234, 334) described above, extruding section (434) is configured to combine the emulsion produced by emulsifying section (431) with at least a second portion of ingredients delivered into inner cavity (421) of barrel (420) via second feeder (424) to create an extrudate that can be used to produce a powdered nutritional product. Extruding section (434) may include one or more processing elements mounted on the central shaft of extruder (410). Extruding section (434) may also be configured to convey the extrudate downstream within extruder (410) so that it can be extruded through a die at the end of extruder (410) or as a cake without a die which can be dried by a continuous vacuum belt dryer with or without microwave or radiant options or combinations thereof.

The high shear elements and processing elements discussed above may be mounted to the central shaft of the extruder (410) so that each element rotates uniformly with the shaft the element is mounted on.

In the illustrated embodiment, first feeder (422) is in communication with inner cavity (421) of barrel (420) so that ingredients may be delivered into inner cavity (421). First feeder (422) may also be in communication with the mixing device (not shown) so that the slurry created by the mixing device may be delivered from the mixing device into extruder barrel (420). As shown, first feeder (422) is positioned such that ingredients delivered via first feeder (422) are delivered to emulsifying section (431) and high shear element (432). As discussed above, first feeder (422) may include two or more separate delivery apparatuses respectively configured to deliver powdered ingredients and liquid ingredients, although this is not necessarily required. Emulsifying section (431) and high shear element (432) may be positioned at or adjacent to the front of barrel (420) (i.e. the end of barrel (420) opposite from the end of barrel (420) where the extrudate is discharged).

In this embodiment, second feeder (424) is also in communication with inner cavity (421) of barrel (420) so that ingredients may be delivered into inner cavity (421). Specifically, second feeder (424) is positioned downstream of first feeder (422) such that ingredients delivered via second feeder (424) are delivered to extruding section (434), which is located downstream of emulsifying section (431) and high shear element (432). As discussed above, second feeder (424) may include two or more separate delivery apparatuses respectively configured to deliver powdered ingredients and liquid ingredients, although this is not necessarily required. As shown, after ingredients are processed by high shear element (432) to produce an emulsion, the emulsion is delivered to extruding section (434), where the emulsion is combined with ingredients delivered via second feeder (424) to form the extrudate. The extrudate is then extruded by the processing elements mounted on the central shaft of extruder (410) in extruding section (434). While the illustrated embodiment depicts two feeders, other suitable numbers of feeders, such as three, four, or more may be used depending on the particular application of a given embodiment.

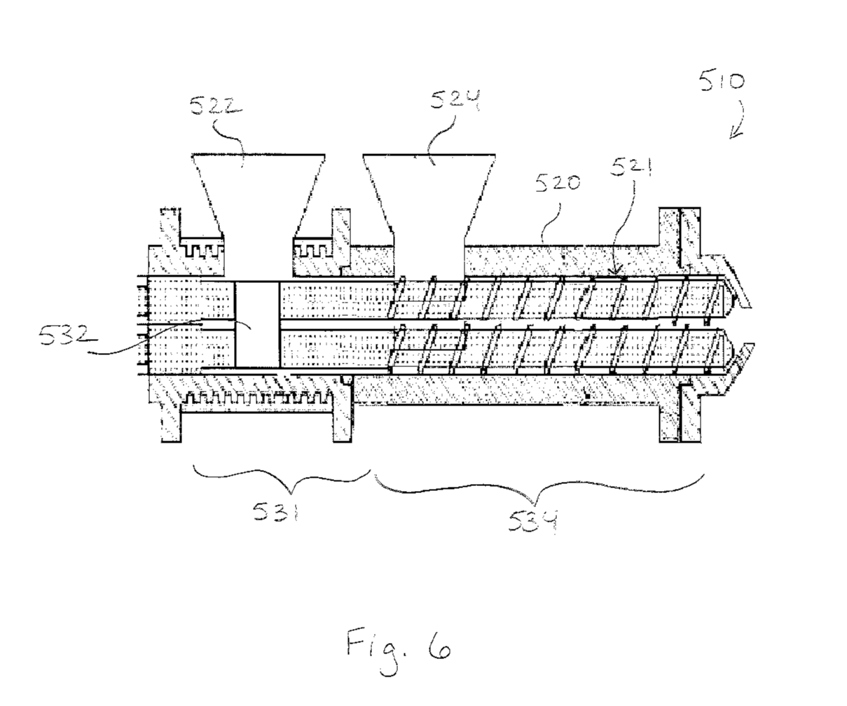

FIG. 6 depicts another particular embodiment of extruder (310), wherein the extruder is a twin screw extruder, such as a co-rotating twin screw extruder or a counter-rotating twin screw extruder. For clarity, the extruder in FIG. 6 is identified herein as extruder (510). Extruder (510) comprises a barrel (520) with an inner cavity (521), a first feeder (522) and a second feeder (524). As shown, extruder (510) includes an emulsifying section (531) and an extruding section (534) within extruder barrel (520). Similar to extruders (310, 410) described above, in this embodiment, a mixing device (not shown) is positioned external to barrel (520) of extruder (510) that is configured to create a slurry by mixing, but not emulsifying, at least a portion of the ingredients required for a desired powdered nutritional product. It should be noted that high shear element (532) is shown schematically in FIG. 6. It should also be noted that feeders (522, 524) and the elements mounted on the central shafts of extruder (510) (e.g., processing elements) are shown generically in FIG. 6 and the exact number, size, configuration arrangement and other suitable parameters of those components will be selected based on the requirements of a particular application of a given embodiment.

Similar to mixing device (330) describe above, a mixing device (not shown) may be configured to mix a first portion of ingredients to create a slurry outside of extruder barrel (520). The slurry is then delivered via first feeder (522) to emulsifying section (531) inside internal cavity (521) of extruder barrel (520). The mixing device (not shown) may provide a substantially homogeneous slurry to emulsifying section (531) and high shear element (532), which may improve the overall quality of the resulting powdered nutritional product.

Similar to emulsifying sections (31, 131, 231, 331, 431) described above, emulsifying section (531) includes a high shear element (532) that may be mounted on at least one of the central shafts of the extruder (510) and is configured to emulsify a slurry. However, in this embodiment the slurry is produced by a mixing device (not shown) external to extruder (510) rather than a mixing section located within the extruder, as with extruders (10, 110, 210) described above. In embodiments such as the one shown in FIG. 6, where the extruder includes two or more central shafts, the high shear element may comprise a plurality of elements respectively mounted on each one of the central shafts of the extruder. By way of example only, in an embodiment where the extruder is a twin screw extruder, the high shear element may comprise a pair of corresponding elements that are each mounted to a respective central shaft. Those elements may be positioned substantially adjacent to each other or have any other arrangement suitable to create an emulsion having the desired qualities. In such an embodiment, the pair of corresponding elements may each have substantially identical configurations or the pair of elements may have different but complementary configurations suitable to create an emulsion having the desired qualities. In some embodiments, emulsifying section (531) includes two or more high shear elements, although this is not required. In such embodiments, the extruder may include combinations of different types of high shear elements or two or more of the same type of high shear element. In embodiments that include two or more high shear elements, the high shear elements may be positioned successively along the central shaft(s) of the extruder in order to subject the slurry/emulsion to desired shear rates multiple times. By way of example only, in embodiments where the extruder is a twin screw extruder, the high shear element may comprise a first pair of elements respectively mounted on each of the central shafts and a second pair of elements respectively mounted on each of the central shafts downstream of the first pair of elements. In embodiments that include two or more high shear elements, the high shear elements may have substantially the same configuration or they may have different configurations depending on what configurations are suitable to produce an emulsion of the desired quality for a particular application of a given embodiment. Emulsifying section (531) may also include one or more processing elements mounted on the central shafts in addition to high shear element (532), although this is not required. In embodiments where emulsifying section (531) includes one or more processing elements, at least a portion of those elements may be configured to apply a shear rate to the slurry as it travels through emulsifying section (531). Emulsifying section (531) may also be configured to convey the emulsion downstream within extruder (510) to extruding section (534).

Similar to extruding sections (34, 134, 234, 334, 434) described above, extruding section (534) is configured to combine the emulsion produced by emulsifying section (531) with at least a second portion of ingredients delivered into inner cavity (521) of barrel (520) via second feeder (524) to create an extrudate that can be used to produce a powdered nutritional product. Extruding section (534) may include one or more processing elements mounted on the central shafts of extruder (510). Extruding section (534) may also be configured to convey the extrudate downstream within extruder (510) so that it can be extruded through a die at the end of extruder (510) or as a cake without a die which can be dried by a continuous vacuum belt dryer with or without microwave or radiant options or combinations thereof.

The high shear elements and processing elements discussed above may be mounted to the central shafts of the extruder (510) so that each element rotates uniformly with the respective shaft the element is mounted on.

In the illustrated embodiment, first feeder (522) is in communication with inner cavity (521) of barrel (520) so that ingredients may be delivered into inner cavity (521). First feeder (522) may also be in communication with the mixing device (not shown) so that the slurry created by the mixing device may be delivered from the mixing device into extruder barrel (520). As shown, first feeder (522) is positioned such that ingredients delivered via first feeder (522) are delivered to emulsifying section (531) and high shear element (532). As discussed above, first feeder (522) may include two or more separate delivery apparatuses respectively configured to deliver powdered ingredients and liquid ingredients, although this is not necessarily required. Emulsifying section (531) and high shear element (432) may be positioned at or adjacent to the front of barrel (420) (i.e. the end of barrel (420) opposite from the end of barrel (420) where the extrudate is discharged).

In this embodiment, second feeder (524) is also in communication with inner cavity (521) of barrel (520) so that ingredients may be delivered into inner cavity (521). Specifically, second feeder (524) is positioned downstream of first feeder (522) such that ingredients delivered via second feeder (524) are delivered to extruding section (534), which is located downstream of emulsifying section (531) and high shear element (532). As discussed above, second feeder (524) may include two or more separate delivery apparatuses respectively configured to deliver powdered ingredients and liquid ingredients, although this is not necessarily required. As shown, after ingredients are processed by high shear element (532) to produce an emulsion, the emulsion is delivered to extruding section (534), where the emulsion is combined with ingredients delivered via second feeder (524) to form the extrudate. The extrudate is then extruded by the processing elements mounted on the central shafts of extruder (510) in extruding section (534). While the illustrated embodiment depicts two feeders, other suitable numbers of feeders, such as three, four, or more may be used depending on the particular application of a given embodiment.

It will be appreciated that extruders that incorporate a high shear element and associated methods in accordance with the teachings herein may also include additional components and/or additional processing steps before, during and after extrusion. By way of example only, an extruder that incorporates a high shear element, such as extruders (10, 110, 210, 310, 410, 510) discussed above, may also include ultrasonic means to subject the ingredients to ultrasonic energy within the extruder. For example, an extruder may incorporate an ultrasonic unit, such as those described in International Published Patent Application WO 2011/159653, entitled “Ultrasonically-Assisted Extrusion Methods For Manufacturing Powdered Nutritional Products,” published Dec. 22, 2011, the disclosure of which is incorporated by reference herein. Application of ultrasonic energy to the ingredients may improve the quality of the powdered nutritional product that is ultimately produced. The ultrasonic energy could be applied to the ingredients either before or after being processed by the high shear element. Preferably, the ultrasonic energy is applied to the ingredients when they still comprise a substantially low viscosity, such as either when the slurry is being or has been produced by the mixing section/device but before being processed by the high shear element or after the high shear element has produced the emulsion but before additional dry ingredients are added to the emulsion that substantially increase the viscosity of the emulsion. Of course, the inclusion of additional extruder components and/or processing steps, such as the application of ultrasonic energy, is not required.

In some embodiments, the high shear element may comprise a rotating member, such as a disc or blade, and may include one or more openings formed at or near the edges or tips of the rotating member. By way of example only, the openings may comprise slots or round holes or any other suitable shape, and the openings may be evenly spaced around substantially the entire edge of the rotating member, although this is not necessarily required. The number, size, shape, orientation and arrangement of the openings may be selected to provide the desired shear rate while operating at the desired speed and to produce an emulsion with the desired qualities, such as particle size and stability, based on the particular application of a given embodiment. In some embodiments, the openings may be omitted entirely and the high shear element may comprise a rotating member configured to provide the desired shear rate while operating at the desired speed and to produce an emulsion with the desired qualities, such as particle size and stability, based on the particular application of a given embodiment.

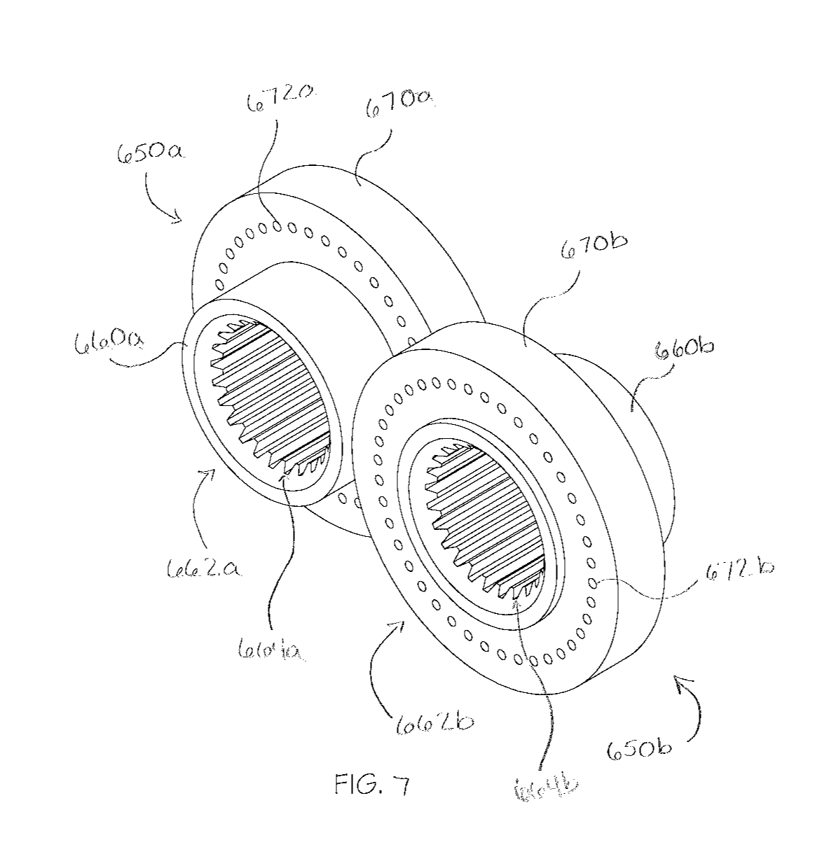

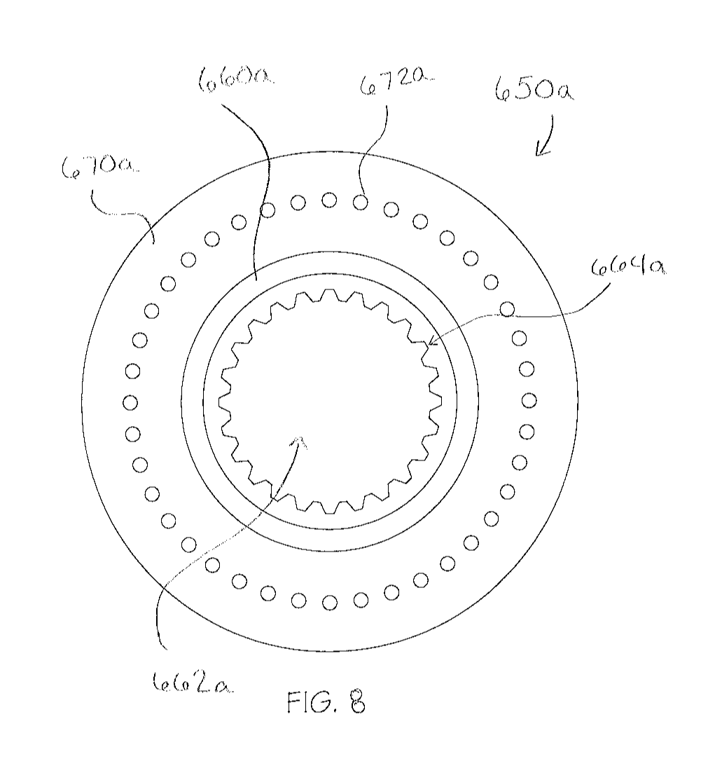

The rotating member configured to serve as a high shear element may have any suitable shape, which may correspond to the shape of the inner cavity of the extruder, provided that the shape of the rotating member is suitable to both provide the desired shear rate to the slurry and still be able to rotate freely within the inner cavity of the extruder barrel. By way of example only, in some embodiments the high shear element may be circular, such as shearing discs (650a, 650b) discussed below and shown in FIGS. 7-9, or oval-shaped.

In addition to the number, size, shape, orientation, and arrangement of the openings in the high shear element, the shear rate created by a rotating member may also be impacted by the diameter of the rotating member and the speed at which the rotating member rotates. Specifically, the tip speed of the rotating member impacts the shear rate applied to the slurry. The tip speed is calculated according to the following formula:

v=n/720×RPM×D

In the above formula, “v” represents tip speed in feet/second, “D” represents the diameter of the rotating member in inches, and “RPM” represents revolutions per minute of the rotating member. In some embodiments, the extruder may be configured to rotate its central shaft(s) and, consequently, the rotating member(s) mounted thereon at a speed within a range of about 100 RPM to about 2,000 RPM, preferably between about 100 RPM and about 1100 RPM, preferably about 250 RPM to about 1,000 RPM, and even more preferably about 500 RPM to about 700 RPM. Although a number of factors contribute to the shear rate, generally speaking as the tip speed increases, the shear rate also increases, assuming that the cross-sectional flow area remains substantially the same. In some embodiments, the rotation speed of the central shaft(s), and, consequently, the rotating member may be varied in order to vary the shear rate applied to the slurry. A change in the shear rate may impact various properties of the resulting emulsion, and, ultimately, the properties of the powdered nutritional product. In some embodiments, the central shaft(s) of the extruder may be operated at the highest RPM possible that produces an emulsion having the desired qualities but does not result in the emulsion being broken or damaged as it is processed through the subsequent extruding section.

The gap between the outer edge of the rotating member and the inner surface of the inner cavity of the extruder barrel is another factor that may impact the shear rate applied to the slurry as it is processed by the high shear element. In some embodiments, the diameter of the rotating member may be selected to minimize this gap as much as possible, subject to the minimum tolerance required to ensure that the rotating member can freely rotate within the inner cavity of the extruder barrel. In some embodiments, the diameter of the portion of the inner cavity of the extruder barrel that houses the rotating member may be increased relative to other sections of the inner cavity of the extruder barrel to accommodate a rotating member having a diameter that is larger than the diameter of the other sections of the inner cavity of the extruder barrel. Alternatively, in other embodiments, the diameter of the portion of the inner cavity of the extruder barrel that houses the rotating member may be decreased relative to other sections of the inner cavity of the extruder barrel in order to accommodate a rotating member having a diameter that is smaller than the diameter of the other sections of the inner cavity of the extruder barrel, while still maintaining a minimized gap distance between the outer edge of the rotating member and the inner surface of the inner cavity of the extruder barrel.

Various operating parameters, including the speed of rotation, the diameter of the rotating member, and the number, size, shape, arrangement, and orientation of the openings in the rotating member may be optimized to produce the desired shear rate as the slurry is processed by the high shear element/rotating member.

FIGS. 7-9 depict one such embodiment, where the high shear element comprises a pair of corresponding shearing discs (650a, 650b). For example, one or more of the shearing discs (650a, 650b) could be installed on the central shaft of single screw extruders (110, 410) to serve as high shear elements (132, 432) in each of those respective embodiments. Similarly, one or more pairs of the shearing discs (650a, 650b) could be installed on the central shafts of twin screw extruders (210, 510) to serve as high shear elements (232, 532) in each of those respective embodiments.

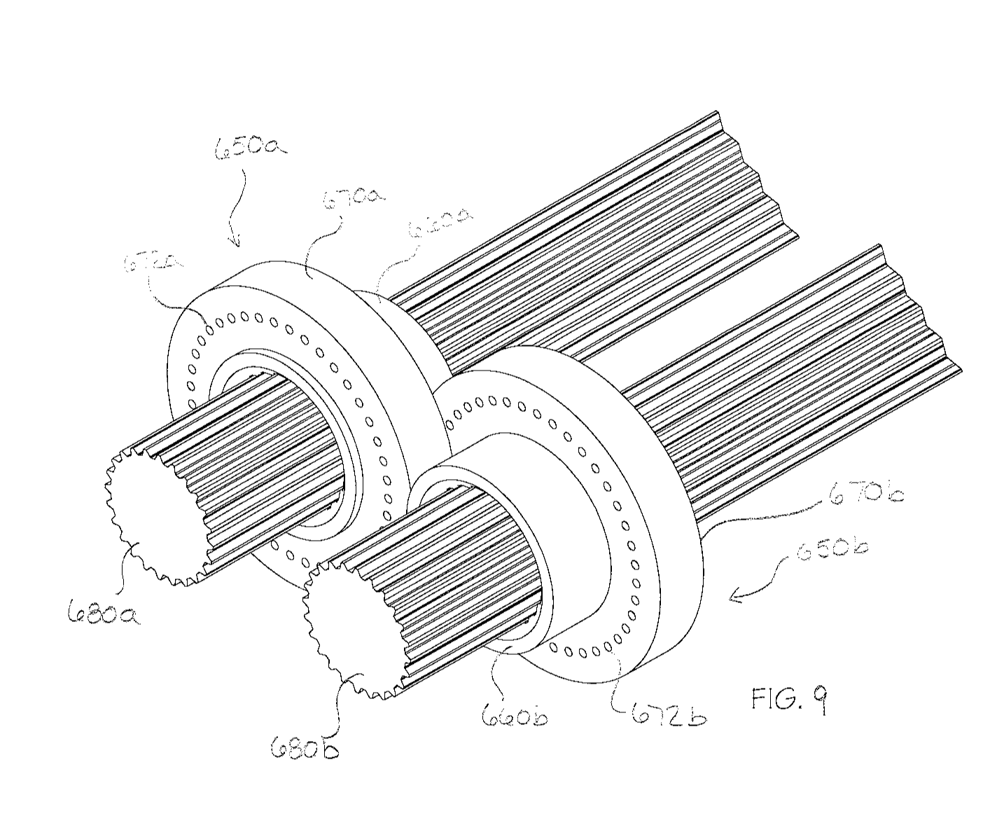

In the illustrated embodiment, shearing discs (650a, 650b) are substantially identical to one another. As shown, each shearing disc (650a, 650b) comprises a central hub (660a, 660b) and an outer lip (670a, 670b). In this embodiment, each central hub (660a, 660b) includes a central opening (662a, 662b) that extends through the entire axial length of central hub (660a, 660b). Central opening (662a, 662b) may be sized and shaped to allow a shearing disc (650a, 650b) to be mounted on a respective central shaft of an extruder, such as central shafts (680a, 680b) shown in FIG. 9. Any type of engagement between shearing discs (650a, 650b) and the central shafts (680a, 680b) suitable to allow shearing discs (650a, 650b) to rotate uniformly with a respective central shaft (680a, 680b) may be used. As shown, central shafts (680a, 680b) include a splined portion that is configured to mate with a series of grooves (664a, 664b) formed on the inner surface of each central hub (660a, 660b).

In the illustrated embodiment, outer lips (670a, 670b) of shearing discs (650a, 650b) each have a larger diameter than the respective central hub (660a, 660b) and extend along a portion of the axial length of central hub (660a, 660b). In other embodiments, outer lips (670a, 670b) may extend along substantially the entire axial length of central hub (660a, 660b). As shown in FIGS. 7-9, shearing discs (650a, 650b) include a series of openings (672a, 672b) that extend through the axial length of each respective outer lip (670a, 670b). As shown, openings (672a, 672b) are circular openings and are arranged in a concentric ring around the central axis of central opening (662a, 662b). In some embodiments, the openings may be about 1 mm in diameter and be positioned about 3 mm from the outer edge of the outer lip. As discussed above, other numbers, sizes, shapes, orientations and arrangements of openings suitable to provide the desired shear rate will be apparent to those of ordinary skill in the art based on the teachings herein. In one such alternate embodiment (not shown), the shearing disc may include one or more indentations along the outer edge of the outer lip instead of or in addition to a series of openings that extend through the outer lip. Additionally, in another alternate embodiment (not shown), the shearing disc may not include any openings or indentations in the outer lip, and the shear rates may be created by the slurry contacting the rotating disc and/or flowing between the outer edge of the outer lip of the shearing disc and the inner surface of the inner cavity of the extruder barrel.

As shown in FIG. 9, the shearing discs (650a, 650b) are mounted onto the central shafts (680a, 680b) of an extruder so that both shearing discs (650a, 650b) can freely rotate uniformly with central shafts (680a, 680b). The shearing discs (650a, 650b) in this embodiment are also mounted onto the central shafts (680a, 680b) in an axially offset manner so that the outer lip (670a, 670b) of each shearing disc (650a, 650b) at least partially overlaps the outer lip (670a, 670b) of the other shearing disc (650a, 650b) in the space between the central shafts (680a, 680b). In other embodiments, the shearing discs may be configured so that the outer lips do not overlap in the space between the central shafts of the extruder. In the illustrated embodiment, shearing discs (650a, 650b) are mounted on the central shafts (680a, 680b) so that the shearing discs (650a, 650b) are substantially adjacent to each other. In other embodiments that include two or more shearing discs, the shearing discs may be mounted onto the central shaft(s) so that the shearing discs are axially spaced apart from each other along the central shaft(s). In still other embodiments, two or more pairs of shearing discs may be mounted on the central shafts of the extruder, and successive pairs of shearing discs may be positioned so that they are substantially adjacent to each other or axially spaced apart from each other along the central shafts.

In the embodiment shown in FIG. 9, shearing discs (650a, 650b) are configured to produce an emulsion by subjecting the slurry to a shear rate and elongational flow as the slurry passes by or through the rotating shearing discs (650a, 650b). Specifically, the shear rate is applied to the slurry when the slurry either passes through the openings (672a, 672b) in the outer lip of one of the shearing discs (650a, 650b) or passes between the outer edge of an outer lip (670a, 670b) of a shearing disc (650a, 650b) and the inner surface of the inner cavity of the extruder barrel. A portion of the slurry that passes in the space between central shafts (680a, 680b) may pass through an opening (672a, 672b) in both shearing discs (650a, 650b). As discussed above, after the slurry is processed by shearing discs (650a, 650b) to produce an emulsion, then the emulsion is conveyed downstream to the extruding section of the extruder.

As mentioned above, any suitable extruder that includes a high shear element as described herein may be suitable for use in the present disclosure, including, for example, single screw extruders, twin screw extruders (either co-rotating or counter-rotating), multi screw extruders, ring screw extruders, planetary gear extruders, etc. The various types of screw extruders comprise at least one rotating shaft or screw. Each shaft may carry a plurality of processing elements disposed axially one behind the other. The processing elements may define various sections along the length of the shaft.

For example, different processing elements may define a feeding and conveying section, at least one mixing section, and a discharging section. These different sections may collectively make up the extruding section (34, 134, 234, 334, 434, 534) in the various embodiments described above. The feeding and conveying section may be positioned farthest upstream, (e.g. close to second feeder (24, 124, 224, 324, 424, 524) in the various embodiments described above). The at least one mixing section may be positioned downstream of the feeding and conveying section, and the discharging section may be positioned farthest downstream, close to the discharge opening of the extruder. Of course other arrangements of processing elements suitable to produce the desired powdered nutritional product may be apparent to those of ordinary skill in the art based on the teachings herein.

Screw-type processing elements may form an endless screw arranged in the desired feed direction and having a uniform pitch flight. Thus, in the feeding and conveying section ingredients may be fed into the extruder and combined with the emulsion delivered from the high shear element and conveyed in the downstream direction, for example at a feed rate of 0.5 to 25 kg/hr, preferably of 0.5 to 10 kg/hr for pilot plant extruders or at a feed rate of about 200 kg/hr to about 1,000 kg/hr for commercial-size extruders. However, the feed rate, flow rate, and entry points to the different barrel sections are dependent on the size of the extruder. Other suitable feed rates, flow rates, and entry points will be apparent to one with ordinary skill in the art based on the teachings herein.

In the mixing section(s), the material to be processed may be mixed or kneaded. Suitably, processing elements such as paddle means or kneading blocks may be used. These kneading blocks may consist of cam disks mutually offset at an angle in a peripheral direction. The cam disks have abutting faces that are perpendicular to the general conveying direction in the extruder. Alternatively, the mixing section(s) are defined by processing element(s) that may comprise a mixing element that may be derived from a screw type element. A mixing element “being derived from a screw type element” is intended to mean an element whose basic shape is that of a screw element, but which has been modified such that it exerts a compounding or mixing effect in addition to a conveying effect. Further, the extruding section may comprise one or more than one, for example three or four, mixing sections, which are connected by intermediate conveying sections formed by screw-type elements.

The central shaft(s) may further comprise one or more than one reverse-flight section(s), preferably arranged after the (last) mixing section and defined by reverse-flight elements. A reverse-flight element has a screw with a reverse-flight relative to the screw-type elements which may be arranged in the feeding and conveying section which define the general conveying direction of the extruder. Thus, the reverse-flight element conveys the material in an opposite direction relative to the general conveying direction of the extruder and serves to create sufficient back-pressure to allow for a desired degree of mixing and/or homogenization. The reverse-flight element is designed to slow the material conveyed in the extruder. Therefore, it may also be called a back-pressure element.

The substances which are fed into and processed by the extruder may be melted in order to melt and to disperse or dissolve the components efficiently. For example, in some embodiments, at least a portion of the extruder barrel may be heated in order to form a melt from the substances fed into the extruder. It will be appreciated that the working temperatures will also be determined by the kind of extruder or the kind of configuration within the extruder that is used. A part of the energy needed to melt, mix, and dissolve the components in the extruder can be provided by heating elements, while the friction and shearing of the material in the extruder can also provide the mixture with a substantial amount of energy and aid in the formation of a homogenous melt of the components. In order to obtain a homogenous distribution and a sufficient degree of dispersion of the active ingredient, the melt may be kept in the heated portion(s) barrel of the extruder for a sufficient length of time.

In one embodiment, the barrel of the extruder may be divided into several heating zones. The temperature in these heating zones can be controlled to control the melting of the dispersion. For example, a portion of the barrel sections may be heated to 90° C., and the final barrel section may be heated to 80° C. in some embodiments, the residence time within the extruder may range between about 55 seconds and 3 minutes.

After being discharged from the extruder, the extrudate may be subjected to one or more post extrusion processing steps (as indicated by Post Extrusion Processing steps (36, 336)). For example, the extrudate may be dried from a moisture content of about 10% to about 20%, preferably about 10% to about 13%, upon exiting the extruder to a moisture content of less than about 5% after being dried. For instance, the extrudate may be dried using a microwave dryer. After the composition has been extruded, the composition may be subjected to radiation via a microwave dryer. The extruded material may be transported through the microwave dryer via a conveyor passing through the microwave dryer. The conveyor may deposit the extruded material across the conveyor at a uniform density and a uniform thickness for uniform product characteristics. The desired depth of the product may vary depending on the penetration depth of the microwave emitter.

The microwave dryer may use air flow in the interior of the microwave dryer to further aid in drying the wet extrudate. The air flow may be heated and/or dried prior to entering the microwave dryer, or the air may be ambient air as it exists near the process site.

Once dried, the extrudate may be milled to obtain the desired particle size. Milling may include grinding a solid dispersion product that exits the extruder or vacuum belt dryer to granules. The granules may then be compacted. Compacting means a process whereby a powder mass comprising granules is condensed under high pressure to obtain a compact with low porosity, e.g., a tablet. Compression of the powder mass is usually done in a tablet press, more specifically in a steel die between two moving punches.

For powder embodiments, such powders are typically in the form of flowable or substantially flowable particulate compositions, or at least particulate compositions that may be easily scooped and measured with a spoon or similar other device, wherein the compositions can easily be reconstituted by the intended user with a suitable aqueous fluid, typically water, to form a liquid nutritional formula for immediate oral or enteral use. In this context, “immediate” use generally means within about 48 hours, most typically within about 24 hours, preferably right after reconstitution. These powder embodiments may typically be made by the extrusion process discussed herein. The quantity of a nutritional powder required to produce a volume suitable for one serving can vary.

The formulas may be packaged and sealed in single or multi-use containers, and then stored under ambient conditions for up to about 36 months or longer, more typically from about 12 to about 24 months. For multi-use containers, these packages can be opened and then covered for repeated use by the ultimate user, provided that the covered package is then stored under ambient conditions (e.g., avoid extreme temperatures) and the contents used within about one month or so.

The following data further illustrates the extruders and related methods of the present disclosure.

Data

A series of trials was conducted using methods similar to the embodiments shown in FIGS. 1 and 3 to produce an extrudate for a powdered infant formula. In particular, samples from trials 403 and 408 and the associated analysis were selected for inclusion herein, because they represented the best opportunity to compare the quality of an emulsion produced within an extruder using conventional processing elements to the quality of an emulsion produced within an extruder using a high shear element.

Specifically, trials 403 and 408 were conducted using a twin screw extruder that included a mixing section, an emulsifying section, and an extruding section. The central shafts of the extruder were rotating at approximately 700 RPM during each trial. In each trial, a first portion of ingredients comprising about 100% of the water required to produce the powdered infant formula and an amount of protein that was less than 100% of the total protein required to produce the powdered infant formula but was sufficient to emulsify the fat contained in the first portion of ingredients was delivered into the mixing section of the extruder. The first portion of ingredients further comprised about 100% of the fat required to produce the powdered infant formula. The first portion of ingredients was processed by the mixing section to produce a slurry, which was then processed by the emulsifying section to produce an emulsion. The emulsion was subsequently combined with a second portion of ingredients and processed by the extruding section. The second portion of ingredients comprised the remaining ingredients required to produce the powdered infant formula. The formulation of the extrudate was substantially identical for each of the trials. Similarly, the process parameters for the extruder, including the speed of the central shafts, product temperature, temperatures of the extruder barrels, water temperature, flow rates and timing of the introduction of the ingredients, were all substantially similar for each of the trials.

The only substantive difference between trials 403 and 408 was the extruder setup. The extruder setup for trial 403 did not include any high shear elements and included conventional processing elements in the mixing, emulsification, and extruding sections. The extruder setup for trial 408 was substantially identical to the extruder setup for trial 403 in the mixing and extruding sections. However, for trial 408, the conventional processing elements from trial 403 were removed from the emulsifying section of the extruder and replaced with a high shear element. Specifically, for trial 408, the high shear element comprised a pair of shearing discs similar to those shown in FIGS. 7-9 and described above.

Samples of the final extrudate produced during each trial were taken at different times during each trial and subsequently analyzed. In the analysis included below, the first sample taken during trial 403 is identified as sample 403A and the second sample taken during trial 403 is identified as sample 403B. Similarly, the first sample taken during trial 408 is identified as sample 408A and the second sample taken during trial 408 is identified as sample 408B. Each of the samples was analyzed in accordance with the following protocol.

All four of the samples (403A, 403B, 408A, and 408B) were wet extrudate samples. For the first set of analysis included below, each sample was reconstituted by combining 5 grams of the extrudate with 30 ml of water at 40° C. and mixing that combination with a magnetic stirrer for 30 minutes while maintaining 40° C. during the mixing. Each sample was then tested at 1 hour after reconstitution, refrigerated, tested 24 hours after reconstitution, left at room temperature for an hour and tested again for a final time 25 hours after reconstitution. The product was visually examined at each stage for both oil separation and the existence or absence of striation within the sample. The visual examination was conducted under both ambient lighting and oblique lighting at each stage. Finally, the samples were rated on a 1 to 4 scale at each state as well.

The rating scale was as follows:

1=No or trace oil;

2=Multiple, small droplets of oil, <10% coverage of surface;

3=The appearance of larger droplets, >10% coverage of surface; and

4=>40% coverage or existence of distinct separation layer.

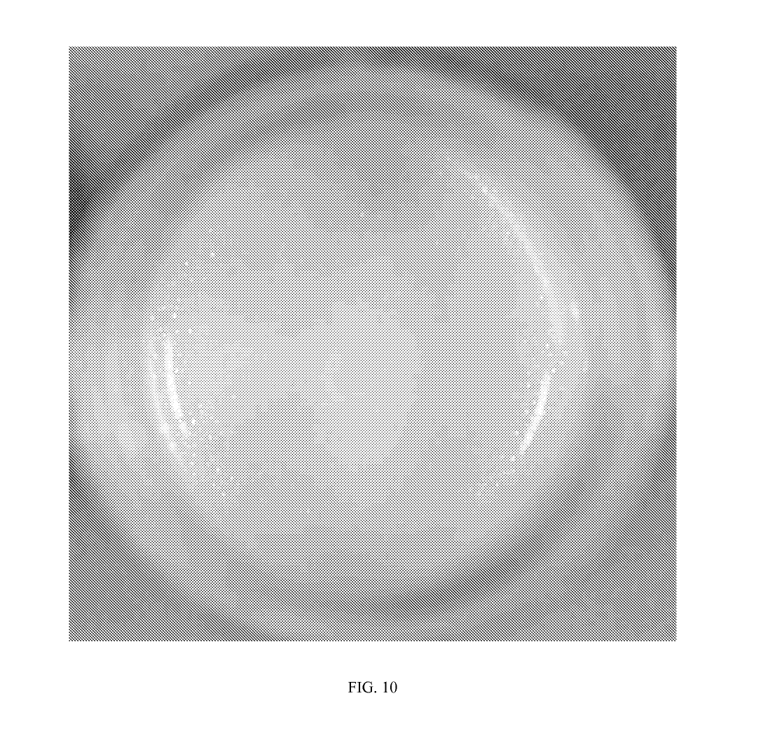

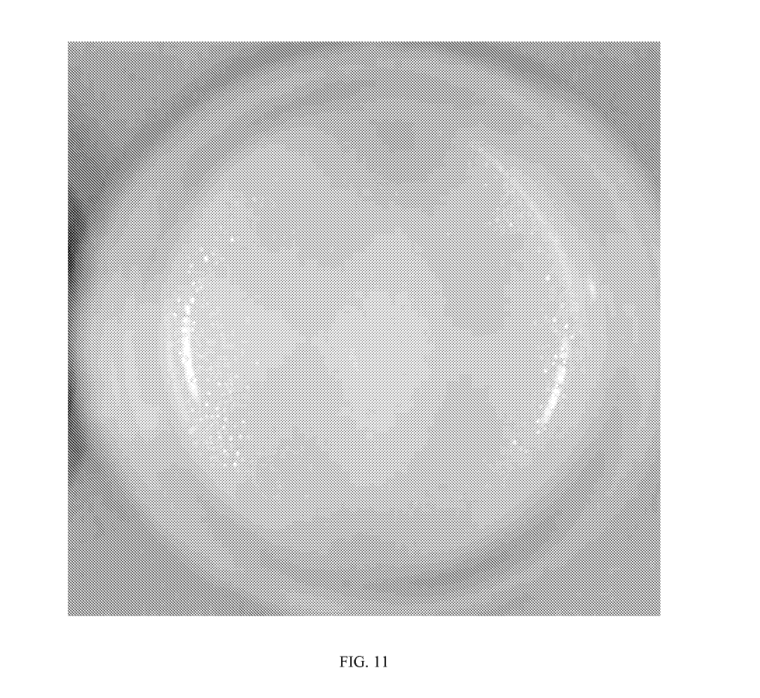

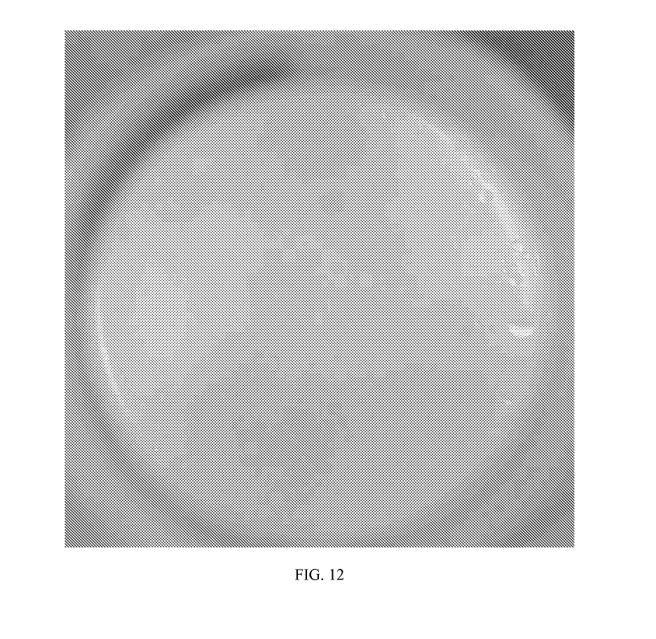

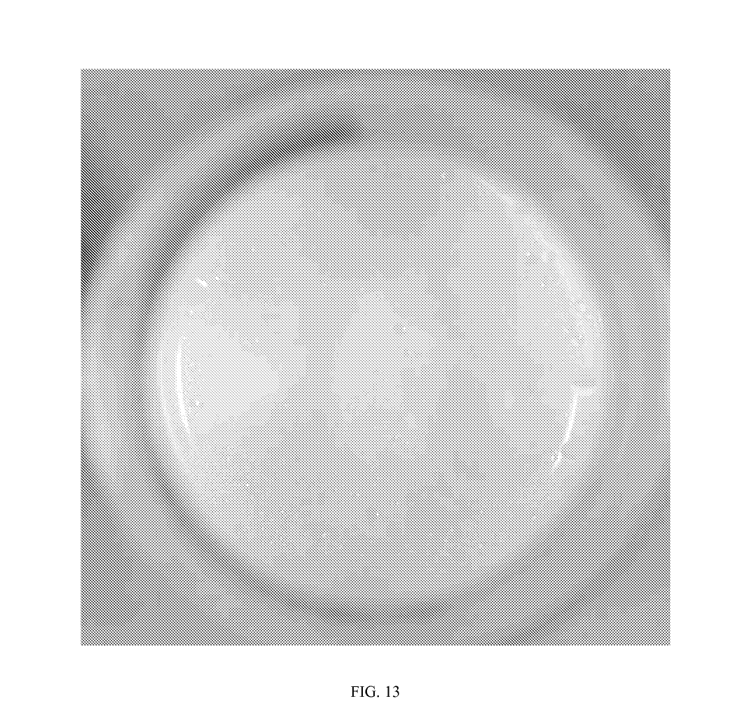

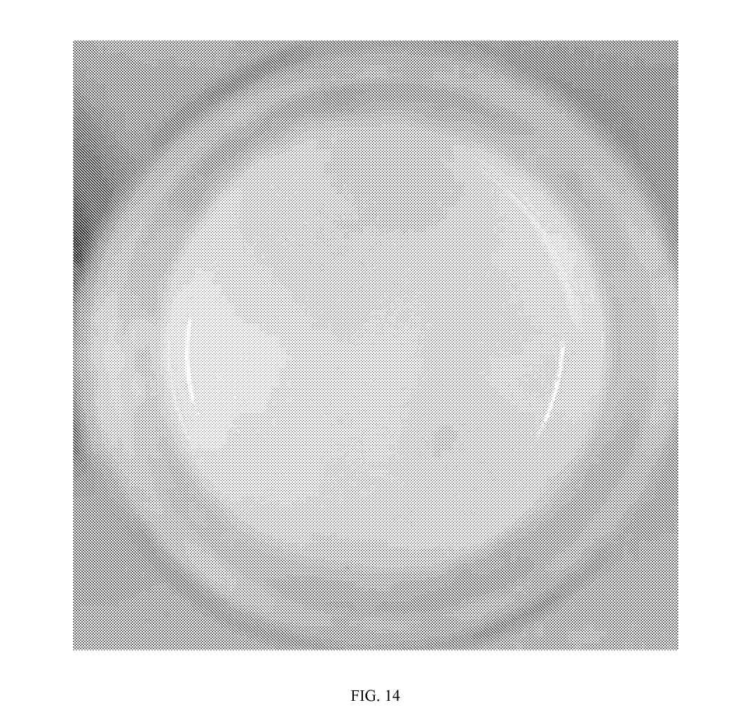

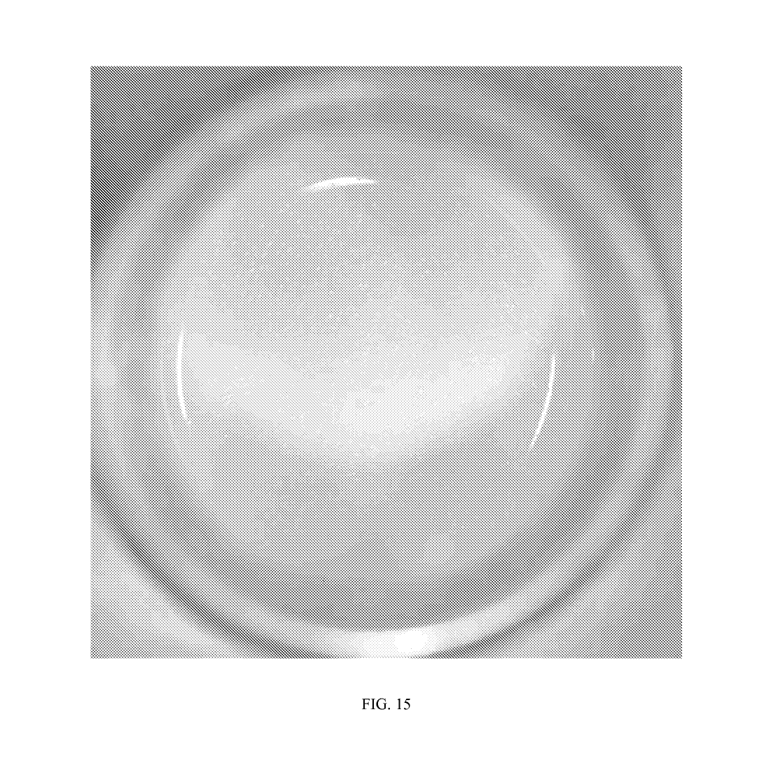

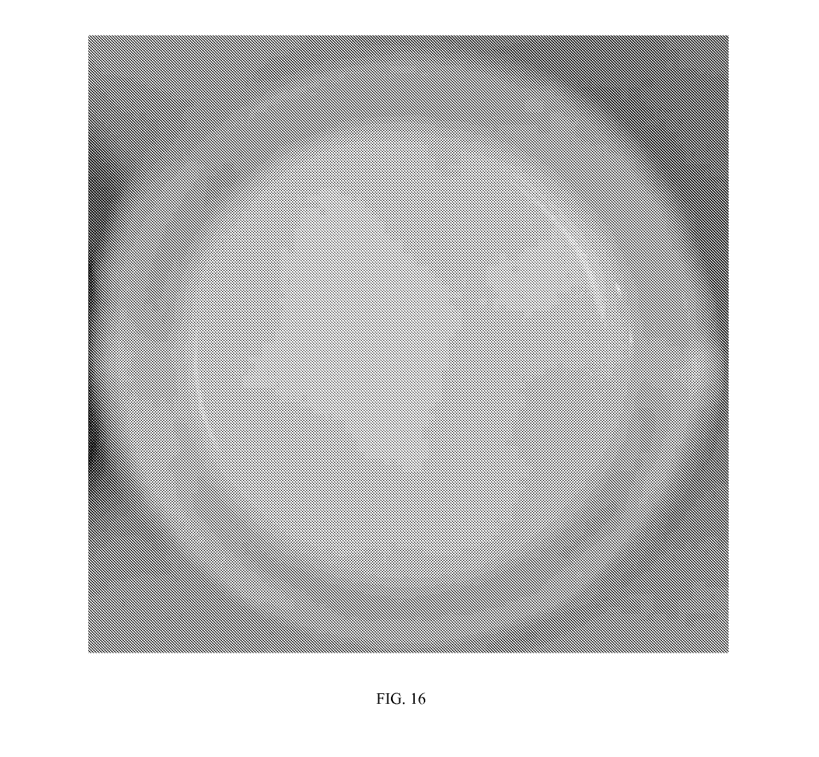

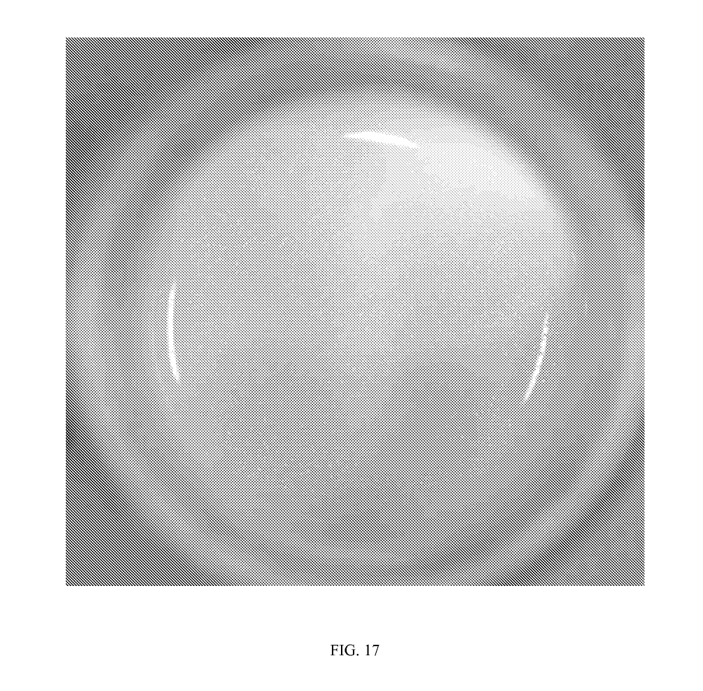

FIGS. 10-17 are photographs of the samples that were taken during the final testing stage (i.e. 25 hours after reconstitution). The results of the first set of analysis are as follows:

| | 403A | 403B | 408A | 408B |
|---|---|---|---|---|
| Comments | No oil, no | No oil, slight | No oil, slight | No oil, no |
| at 1 hr | striation visible | striation visible | striation visible | striation visible |
| | under ambient | under ambient | under ambient | under ambient |
| | lighting. Few, | lighting. Few, | lighting. Some | light. Minor |
| | small droplets | small droplets | striation, no oil | striation, trace |
| | visible with | visible under | visible with | oil visible with |
| | oblique lighting. | oblique lighting. | oblique lighting. | oblique lighting. |
| Rating | 1 | 1 | 1 | 1 |
| at 1 hr | | | | |
| Comments | No oil, slight | Trace oil droplets, | Minor striation, | Minor striation, |
| at 24 hr | striation under | slight striation | no oil under | no oil under |
| | ambient lighting. | with ambient | either ambient or | ambient lighting. |
| | Trace oil (at | light. Trace oil, | oblique lighting. | Minor striation, |
| | most), slight | slight striation | | few, tiny oil |
| | striation with | with oblique | | droplets under |
| | oblique lighting. | lighting. | | oblique lighting. |
| Rating | 1 | 1 | 1 | 1 |
| at 24 hr | | | | |
| Comments | Trace oil drops, | Several large oil | No oil, no | No oil, no |
| at 25 hr | no striation with | drops, no striation | striation under | striation under |
| | ambient light. | under ambient | ambient lighting. | ambient lighting. |
| | Minor oil drops, | lighting. Several | Trace/minor oil | Trace/minor oil |
| | no striation with | large and many | droplets under | droplets under |
| | oblique lighting. | small under | oblique lighting. | oblique lighting. |
| | | oblique lighting. | | |
| Rating at | 1 | 3 | 1 | 1 |
| 25 hrs | | | | |

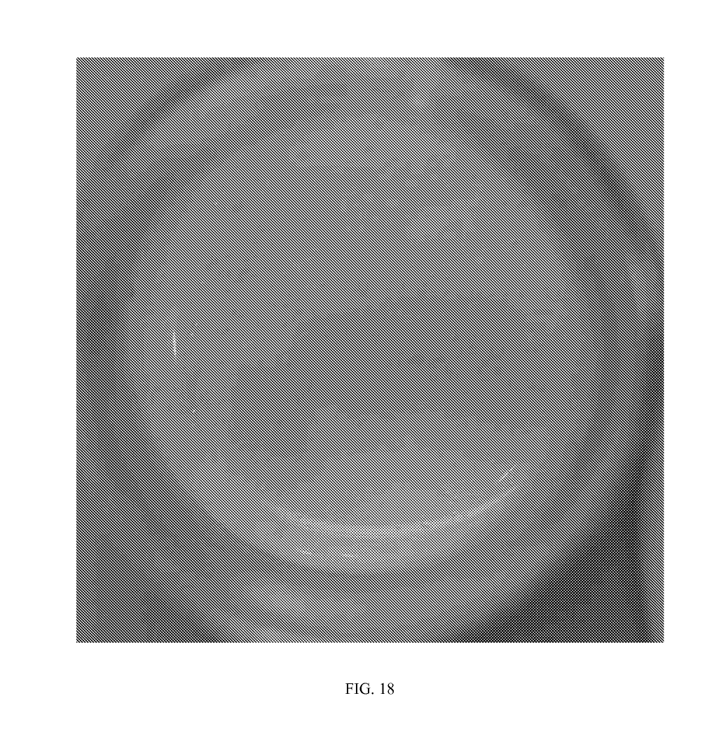

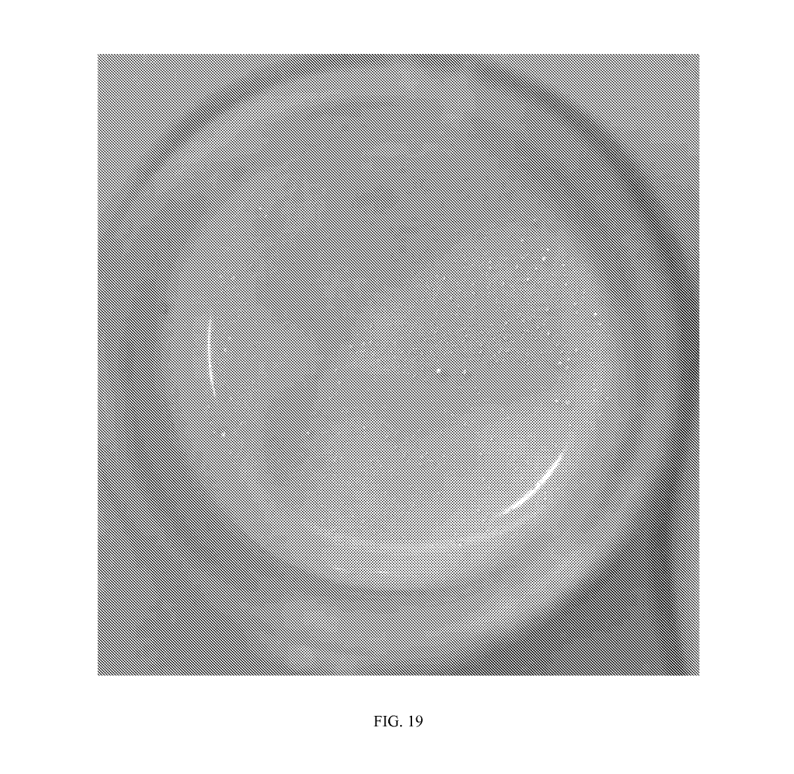

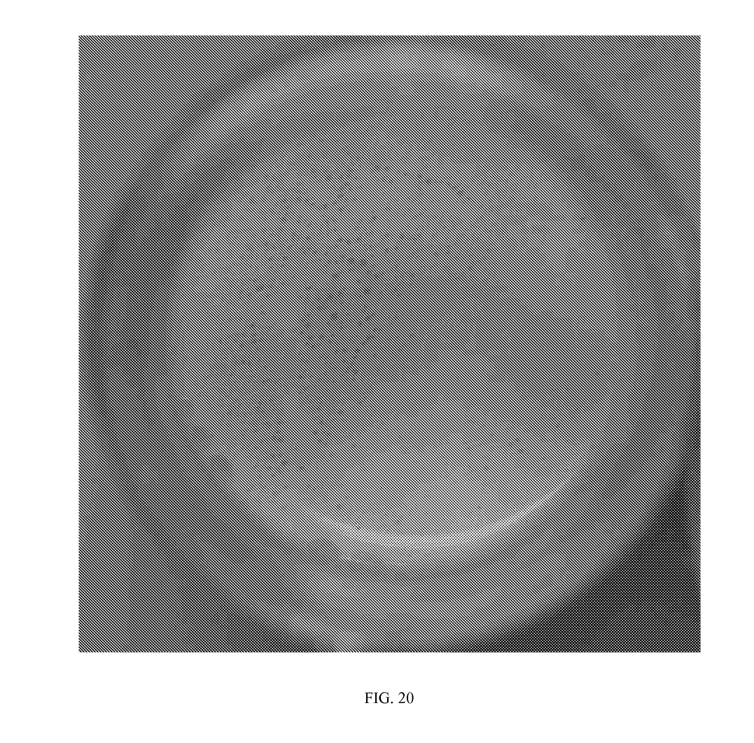

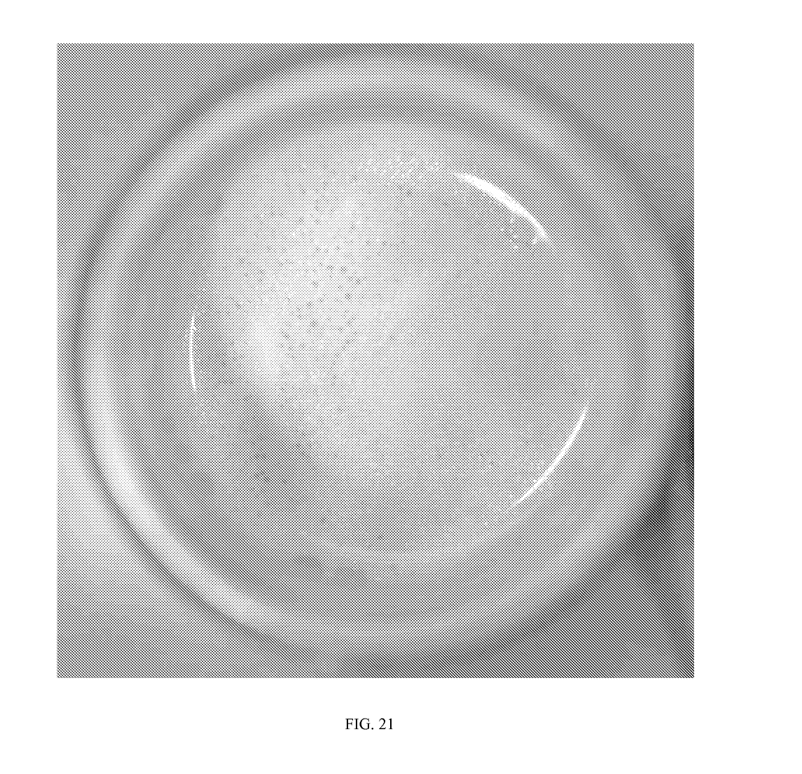

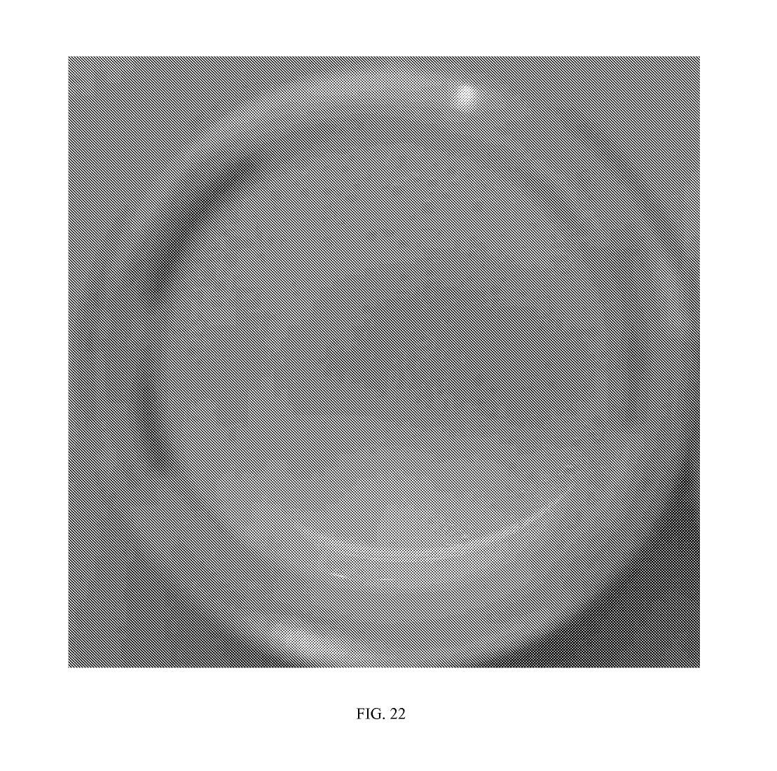

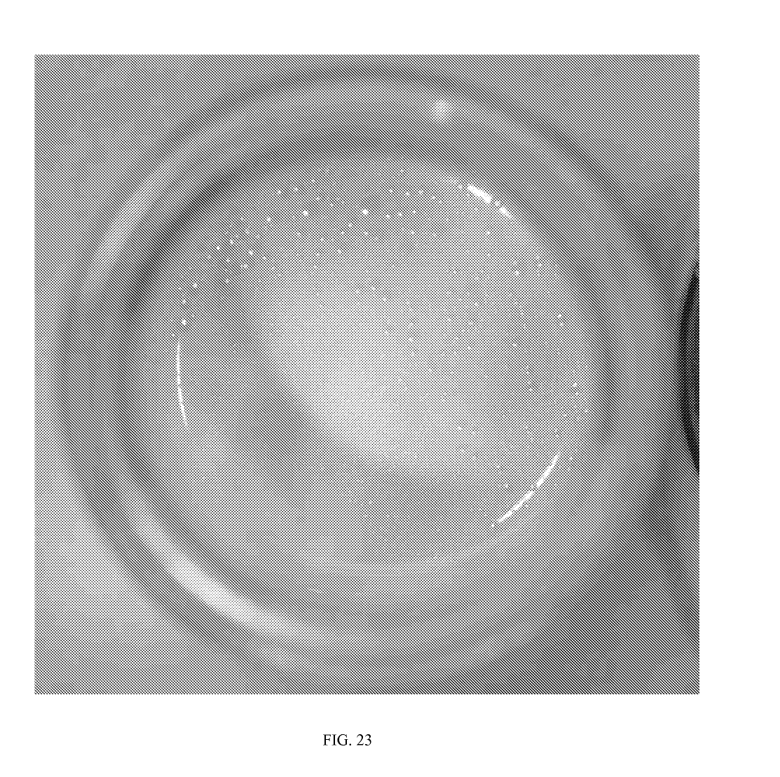

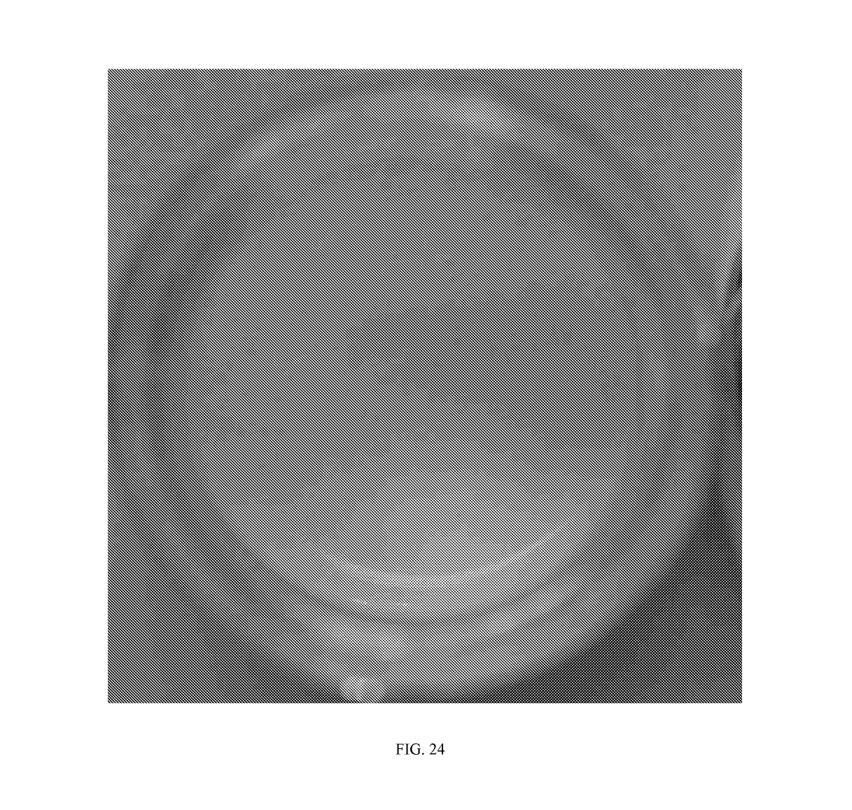

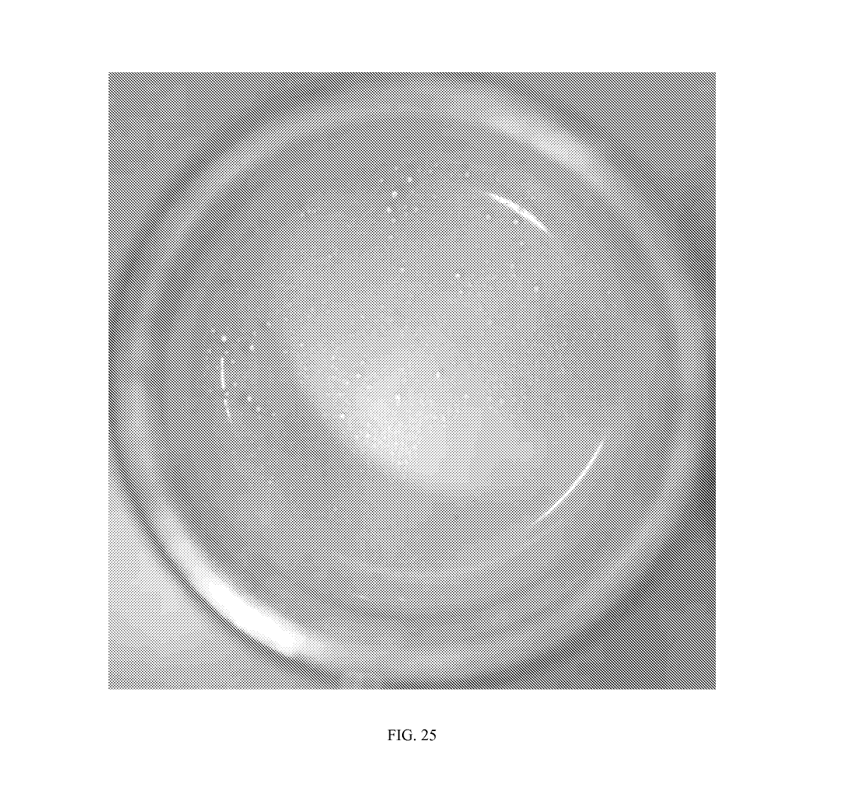

A second set of analysis was also conducted on samples 403A, 403B, 408A, 408B. The protocol for the second set of analysis was substantially identical to the protocol described above for the first set of analysis. However, during the second set of analysis a dye was added to the reconstituted samples to aid in viewing the oil droplets in the reconstituted samples. Additionally, during the second set of analysis, the samples were only analyzed at the 25 hour stage. FIGS. 18-25 are photographs of the samples that were taken at the 25 hour stage. The results of the second set of analysis are as follows:

| | 403A | 403B | 408A | 408B |
|---|---|---|---|---|
| Comments | Moderate oil | Significant | Significant | Significant |
| at 25 hrs | drops with | creaming, | creaming, | creaming, |
| | significant | medium oil | minor oil | minor oil |
| | creaming | drops on | drops under | drops under |
| | under | perimeter, | ambient | ambient |
| | ambient | minor/ | lighting. | lighting. |
| | lighting. | moderate oil | Significant | Significant |
| | Moderate to | in center | creaming, | creaming, |
| | medium oil | under | minor oil | minor oil |
| | drops with | ambient | drops under | drops under |
| | significant | lighting. | oblique | oblique |
| | creaming | Significant | lighting. | lighting. |
| | under | creaming, | | |
| | oblique | medium oil | | |
| | lighting. | drops on | | |
| | | perimeter, | | |
| | | minor/ | | |
| | | moderate oil | | |
| | | in center | | |
| | | under | | |
| | | oblique | | |
| | | lighting. | | |
| Rating at | 2 | 3 | 1 (under | 1 (under |
| 25 hrs | | | visual | visual |
| | | | inspection); | inspection); |
| | | | 2 (under | 2 (under |
| | | | photographic | photographic |
| | | | inspection) | inspection) |

It should be understood that any one or more of the teachings, expressions, embodiments, examples, etc. described herein may be combined with any one or more of the other teachings, expressions, embodiments, examples, etc. that are described herein. The teachings, expressions, embodiments, examples, etc. described herein should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A method of producing an emulsion for a powdered nutritional product within an extruder comprising the steps of:
a) providing an extruder comprising
i) a barrel, and
ii) a high shear element positioned within the barrel;
b) delivering a first portion of ingredients to the high shear element; and
c) emulsifying the first portion of ingredients by processing the first portion of ingredients through the high shear element to produce an emulsion, wherein, prior to emulsification, the first portion of ingredients comprises a slurry.

2. The method of claim 1, wherein the high shear element emulsifies the slurry by subjecting at least a portion of the slurry to a shear rate between about 30 sec⁻¹ and about 2,500 sec⁻¹.

3. The method of claim 2, wherein the high shear element emulsifies the slurry by subjecting at least a portion of the slurry to a shear rate of at least 100 sec⁻¹.

4. The method of claim 1, wherein the first portion of ingredients comprises a protein content that is less than a total amount of protein required to produce the powdered nutritional product, but is sufficient to emulsify any fat contained in the first portion of ingredients.

5. The method of claim 1, wherein the first portion of ingredients further comprises:
a) a fat content that is about 100% of an amount of fat required to produce the powdered nutritional product; and
b) a water content that is about 100% of an amount of water required to produce the powdered nutritional product.

6. The method of claim 1, wherein the high shear element comprises at least one shearing disc.

7. The method of claim 1, wherein the extruder comprises a twin screw extruder comprising a first central shaft and a second central shaft.

8. The method of claim 7, wherein the high shear element comprises a first shearing disc mounted on the first central shaft and a second shearing disc mounted on the second central shaft.

9. The method of claim 8, wherein the extruder further comprises a second high shear element positioned within the barrel, wherein the second high shear element comprises a third shearing disc mounted on the first central shaft and a fourth shearing disc mounted on the second central shaft.

10. A method of producing an extrudate for a powdered nutritional product comprising the steps of:
a) providing an extruder comprising
i) a barrel,
ii) a first feeder in communication with the barrel,
iii) a second feeder in communication with the barrel and positioned downstream relative to the first feeder,
iv) at least one central shaft positioned within the barrel,
v) an emulsifying section positioned between the first feeder and the second feeder, wherein the emulsifying section comprises a rotating high shear element engaged with the at least one central shaft,
vi) a mixing section positioned upstream relative to the emulsifying section, and
vii) an extruding section positioned downstream relative to the emulsifying section;
b) delivering a first portion of ingredients into the barrel via the first feeder;
c) processing the first portion of ingredients through the mixing section to produce a slurry;
d) processing the slurry through the emulsifying section to produce an emulsion;
e) delivering a second portion of ingredients into the barrel via the second feeder;
f) combining the emulsion and the second portion of ingredients to form an extrudate; and
g) processing the extrudate through the extruding section.

11. The method of claim 10, wherein the emulsifying section further comprises at least one processing element engaged with the at least one central shaft.

12. The method of claim 10 wherein step (d) is accomplished by rotating the at least one central shaft and the rotating high shear element at a speed between about 100 RPM and about 1100 RPM.

13. The method of claim 10, wherein the extruder further comprises an ultrasonic unit positioned upstream relative to the extruding section.

14. The method of claim 10, wherein the rotating high shear element comprises a first shearing disc mounted onto the at least one central shaft, wherein the first shearing disc comprises
a) a central hub comprising a central opening; and
b) an outer lip that extends radially around the central hub and comprises an axial length and an outer edge.

15. The method of claim 14, wherein the outer lip further comprises a plurality of openings that extend through the outer lip along the axial length of the outer lip.

16. The method of claim 14, wherein the outer lip further comprises a plurality of indentations along at least a portion of the outer edge of the outer lip.

17. A method of producing an extrudate for a powdered nutritional product comprising the steps of:
a) providing a twin screw extruder comprising
i) a barrel,
ii) a first central shaft positioned within the barrel,
iii) a second central shaft positioned within the barrel,
iv) a first shearing disc mounted on the first central shaft,
v) a second shearing disc mounted on the second central shaft, wherein the second shearing disc is positioned substantially adjacent to the first shearing disc, and
vi) an extruding section positioned within the barrel, wherein the extruding section is positioned downstream relative to the first shearing disc and the second shearing disc;
b) emulsifying a first portion of ingredients by processing the first portion of ingredients through the first shearing disc and the second shearing disc to produce an emulsion, wherein, prior to emulsification, the first portion of ingredients comprises a slurry;
c) delivering the emulsion and a second portion of ingredients to the extruding section; and
d) extruding the emulsion together with the second portion of ingredients in the extruding section.

18. The method of claim 17, wherein the second portion of ingredients comprises substantially all ingredients required to produce the powdered nutritional product not included in the first portion of ingredients.

19. The method of claim 1, wherein the slurry is produced outside the extruder.

20. The method of claim 17, wherein the slurry is produced outside the extruder.
